(19) United States
(12) Patent Application Publication
(10) Pub. No.: US 2025/0222710 A1
(43) Pub. Date: Jul. 10, 2025

(54) THERMAL TRANSFER RECORDING MEDIUM AND PRINTING DEVICE

(71) Applicants: BROTHER KOGYO KABUSHIKI KAISHA, Nagoya-shi, Aichi (JP); General Co., Ltd., Osaka-shi, Osaka (JP)

(72) Inventors: Masaya FUJITA, Nagoya-shi, Aichi (JP); Satoru ITO, Nagoya-shi, Aichi (JP); Mina KATAOKA, Nagoya-shi, Aichi (JP); Haruki MATSUMOTO, Nagoya-shi, Aichi (JP); Yuki HOKARI, Nagoya-shi, Aichi (JP); Hiroaki NARUSE, Osaka-shi, Osaka (JP); Jiro HIRANO, Osaka-shi, Osaka (JP)

(73) Assignees: BROTHER KOGYO KABUSHIKI KAISHA, Nagoya-shi, Aichi (JP); General Co., Ltd., Osaka-shi, Osaka (JP)

(21) Appl. No.: 18/854,021

(22) PCT Filed: Apr. 27, 2023
(86) PCT No.: PCT/JP2023/016617

§ 371 Date: Oct. 3, 2024

(30) Foreign Application Priority Data
Apr. 28, 2022 (JP) 2022-075254

(51) Int. Cl. B41M 5/44; B41J 11/00; B41J 15/04; B41M 5/52

(52) U.S. Cl. CPC B41M 5/44; B41J 11/0015; B41J 15/044; B41M 5/52; B41M 2205/06; B41M 2205/32; B41M 2205/38

(57) ABSTRACT

A thermal transfer recording medium includes a base material layer having a first surface and a second surface, and a first thermal transfer layer, a middle layer, and a second thermal transfer layer layered in this order in direct contact with each other on the first surface of the base material layer, in which the middle layer includes a thermoplastic elastomer. Since the thermal transfer recording medium includes the middle layer including a thermoplastic elastomer, characters having at least two colors can be recorded with good sharpness.

### CROSS REFERENCE TO RELATED APPLICATIONS

The present application corresponds to Japanese Patent Application No. 2022-075254 filed in the Japan Patent Office on Apr. 28, 2022, the entire disclosure of which is incorporated herein by reference.

### TECHNICAL FIELD

The present disclosure relates to a thermal transfer recording medium enabling characters having different colors to be recorded, and a printing device to transfer the thermal transfer recording medium to a printing medium.

### BACKGROUND ART

For example, each of Patent Literatures 1 and 2 discloses a thermal transfer recording medium capable of recording characters having different colors (for example, two colors including black and red). This type of thermal transfer recording medium is set in a dedicated printing device. Characters having different colors can be transferred to a printing medium by adjusting an energy amount applied to a thermal head of the printing device.

### CITATION LIST

### Patent Literatures

Patent Literature 1: Japanese Patent Application Publication No. 2000-094843
Patent Literature 2: Japanese Patent Application Publication No. S62-227788
Patent Literature 3: Japanese Patent Application Publication No. S63-214481

### SUMMARY OF INVENTION

### Technical Problem

A preferred embodiment of the present disclosure provides a thermal transfer recording medium enabling characters having at least two colors to be recorded with good sharpness.

### Solution to Problem

A thermal transfer recording medium according to a preferred embodiment of the present disclosure includes a base material layer having a first surface and a second surface, and a first thermal transfer layer, a middle layer, and a second thermal transfer layer layered in this order in direct contact with each other on the first surface of the base material layer, in which the middle layer includes a thermoplastic elastomer.

### Advantageous Effects of Invention

Since the thermal transfer recording medium according to a preferred embodiment of the present disclosure includes the middle layer including a thermoplastic elastomer, characters having at least two colors can be recorded with good sharpness.

### BRIEF DESCRIPTION OF DRAWINGS

FIG. 1 is a view schematically illustrating a structure of a printing device according to a preferred embodiment of the present disclosure.

FIG. 2 is a block diagram illustrating an electrical configuration of the printing device.

FIG. 3 is a schematic view illustrating a heating step and a cooling step of the printing device.

FIGS. 4A and 4B are schematic views illustrating a cooling step and a transferring step of the printing device.

FIGS. 5A and 5B are views illustrating an example of a printing pattern of the printing device.

FIG. 6 is a schematic cross-sectional view illustrating a layer configuration of an ink ribbon according to a preferred embodiment of the present disclosure.

FIG. 7 is a graph illustrating a relationship between an elapsed time and a reaching temperature of the thermal transfer recording medium in the heating step and the cooling step.

FIG. 8 is a graph illustrating a relationship between an elapsed time and an interlayer adhesive force of the thermal transfer recording medium in the heating step and the cooling step.

FIG. 9 is a graph illustrating a relationship between an elapsed time and an interlayer adhesive force of the thermal transfer recording medium in the heating step and the cooling step.

FIG. 10 is a view illustrating a peeling state of the thermal transfer recording medium.

FIG. 11 is a view illustrating a peeling state of the thermal transfer recording medium.

FIG. 12 is a view illustrating a peeling state of the thermal transfer recording medium.

FIG. 13 is a view illustrating a peeling state of the thermal transfer recording medium.

FIG. 14 is a view illustrating a peeling state of the thermal transfer recording medium.

FIG. 15 is a view illustrating a peeling state of the thermal transfer recording medium.

FIG. 16 is a diagram for comparing solubility parameters (SP values) of constituent materials of a thermal transfer recording medium according to a preferred embodiment of the present disclosure.

FIG. 17 is a diagram illustrating a relationship between a kind of a material constituting a part of the thermal transfer recording medium and a magnitude of a solubility parameter.

### DESCRIPTION OF EMBODIMENTS

Next, preferred embodiments of the present disclosure will be described in detail with reference to the accompanying drawings.

### [Overall Configuration of Printing Device 1]

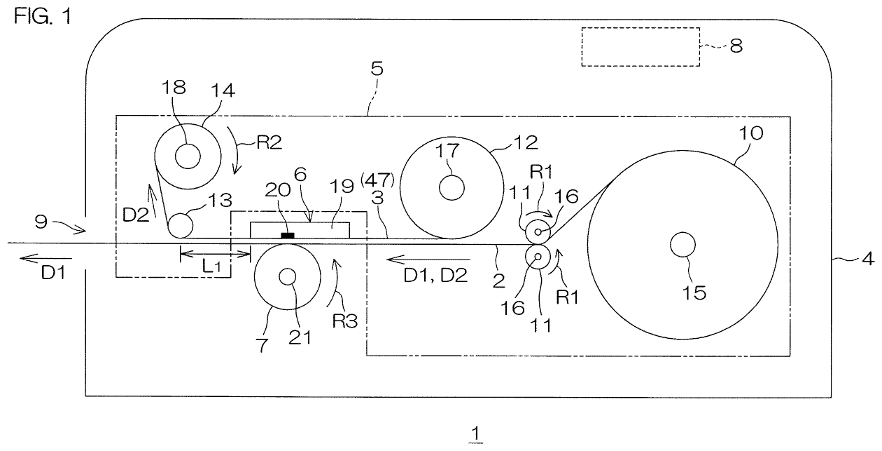

FIG. 1 is a view schematically illustrating a structure of a printing device 1 according to a preferred embodiment of the present disclosure.

With reference to FIG. 1, the printing device 1 is a thermal transfer printer that thermally transfers ink of an ink ribbon 3 as characters to a printer tape 2 as an example of a printing medium. The printer tape 2 may include, for example, a band-shaped film tape including a base material to which ink is directly transferred, a paper label tape in which a large number of paper labels are arranged on a band-shaped base film, and the like.

Examples of characters to be recorded on the printer tape 2 may include a typical character, a symbol such as a barcode or a QR code (registered trademark), a number, a figure, a pattern, and the like. The printing device 1 according to this preferred embodiment can record characters having different colors (for example, two colors including black and red) on the printer tape 2.

The printing device 1 mainly includes a housing 4, and a tape cassette 5, a thermal head 6, a platen roller 7, and a control board 8 which are accommodated inside the housing 4.

The housing 4 may be a box-shaped member formed by, for example, a plastic case. An outlet 9 for taking out the printer tape 2 after printing is formed on an outer wall of the housing 4. A cutter (not illustrated) may be provided in the vicinity of the outlet 9. Cutting is performed using the cutter, and thereby the printer tape 2 can be separated into labels having a size for each usage unit and taken out.

The tape cassette 5 may be a removable cartridge with respect to the housing 4. The tape cassette 5 may accommodate a printer tape roll 10 (in other words, may be referred to as a label tape roll), a supply roller 11, an ink ribbon roll 12, an ink ribbon peeling member 13, and an ink ribbon winding roll 14 in this order from an upstream side to a downstream side in a tape feeding direction D1 (a direction from right to left in FIG. 1). In this preferred embodiment, the printer tape roll 10 and the ink ribbon roll 12 are types used in a state of being accommodated in the tape cassette 5, but may be, for example, types used by being directly attached to the printing device 1.

The printer tape roll 10 is manufactured by winding the printer tape 2 in a cylindrical shape, and is rotatably held by the tape cassette 5, for example. A tape drive shaft 16 provided in the housing 4 is inserted into the supply roller 11. A rotative force R1 generated by driving the tape drive shaft 16 is transmitted to the supply roller 11, and the supply roller 11 is rotated.

The ink ribbon roll 12 is manufactured by winding the ink ribbon 3 in a cylindrical shape, and is rotatably held by, for example, the tape cassette 5. A ribbon drive shaft 18 provided in the housing 4 is inserted into the ink ribbon winding roll 14. A rotative force R2 generated by driving the ribbon drive shaft 18 is transmitted to the ink ribbon winding roll 14, and the ink ribbon winding roll 14 is rotated.

The ink ribbon peeling member 13 may be a guide member that changes a feeding direction D2 of the ink ribbon 3. The ink ribbon peeling member 13 may have a shape which can abut the ink ribbon 3 being transported, for example, a roller shape, or a blade shape. A part of the ink ribbon 3 is thermocompression-bonded to the printer tape 2 by the thermal head 6, and is transported together with the printer tape 2 toward the outlet 9. The ink ribbon peeling member 13 abuts the ink ribbon 3 in the middle of transport and changes the feeding direction D2 of the ink ribbon 3 to a steep angle with respect to the feeding direction D1 of the printer tape 2. Consequently, the printer tape 2 and the ink ribbon 3 are separated from each other, and the ink ribbon 3 is peeled from the printer tape 2.

The thermal head 6 is located between the ink ribbon peeling member 13 and both the printer tape roll 10 and the ink ribbon roll 12 in the feeding direction D1 of the printer tape 2. The thermal head 6 includes a substrate 19 and a heating element 20 (for example, a heating resistor or the like) formed on the substrate 19. Joule heat generated by energization to the heating element 20 is used for thermal transfer of ink of the ink ribbon 3.

For example, a platen drive shaft 21 provided in the housing 4 is inserted into the platen roller 7. A rotative force R3 generated by driving the platen drive shaft 21 is transmitted to the platen roller 7, and the platen roller 7 is rotated. The control board 8 is an electronic instrument that executes electrical control of the printing device 1, and is installed inside the housing 4.

### [Electrical Configuration of Printing Device 1]

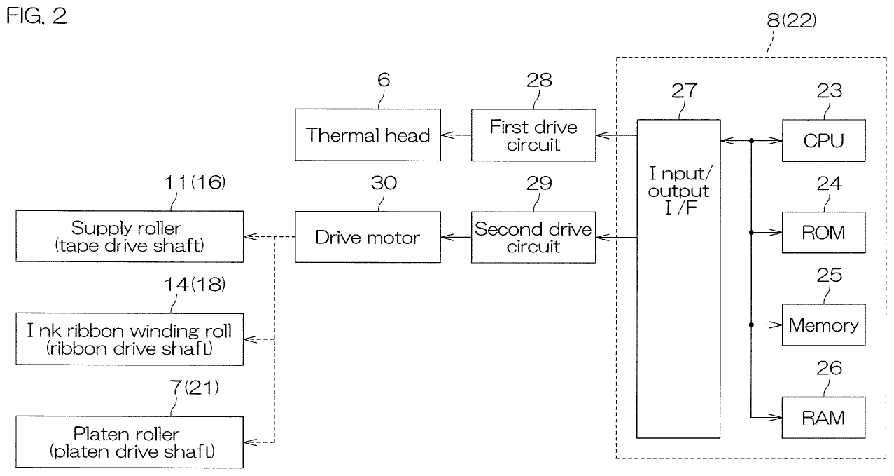

FIG. 2 is a block diagram illustrating an electrical configuration of the printing device 1.

With reference to FIG. 2, a control circuit 22 is provided on the control board 8 of the printing device 1. The control circuit 22 may include a CPU 23, a ROM 24, a memory 25, a RAM 26, and an input/output I/F 27 (interface) These elements are electrically connected through, for example, a data bus (not illustrated).

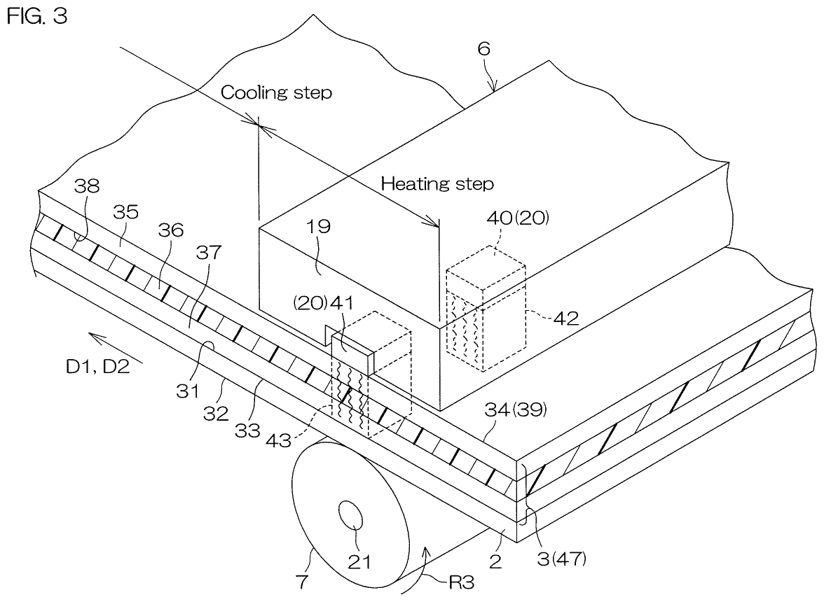

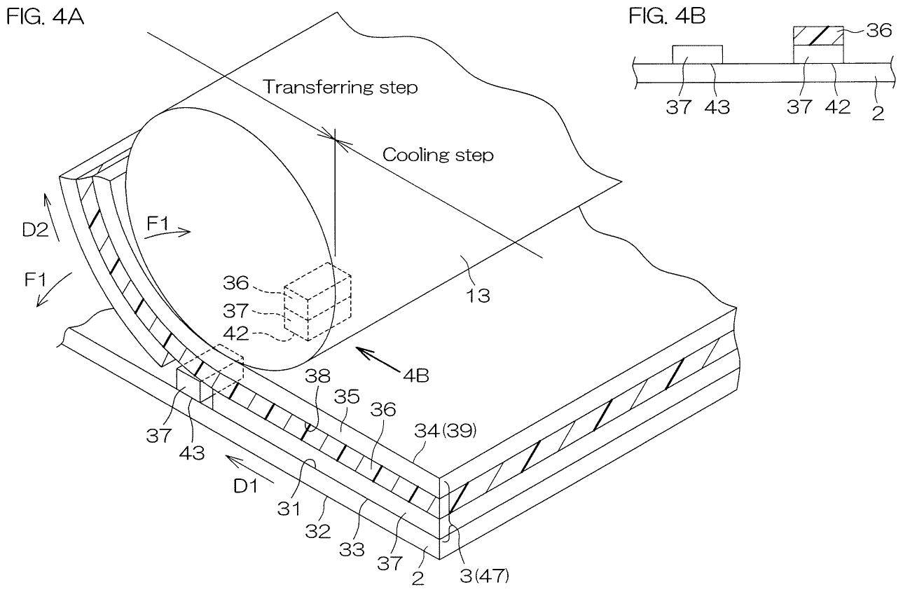

The ROM 24 stores various programs (for example, a control program or the like for executing steps illustrated in FIGS. 3 and 4A and 4B) for driving the printing device 1. The CPU 23 executes signal processing according to a program stored in the ROM 24 while using the temporary storage function of the RAM 26 and controls the printing device 1 as a whole. The memory 25 may be configured of, for example, a part of a storage region of the ROM 24. In the memory 25, a table for displaying a remaining amount (consumption amount) of the ink ribbon 3 on a display portion (not illustrated) of the housing 4 may be stored in advance.

A first drive circuit 28 and a second drive circuit 29 are electrically connected to the input/output I/F 27. The first drive circuit 28 executes energization control of the heating element 20 of the thermal head 6. The second drive circuit 29 executes drive control of outputting a drive pulse to a drive motor 30 that rotationally drives the supply roller 11, the ink ribbon winding roll 14, and the platen roller 7.

### [Flow of Printing Step by Printing Device 1]

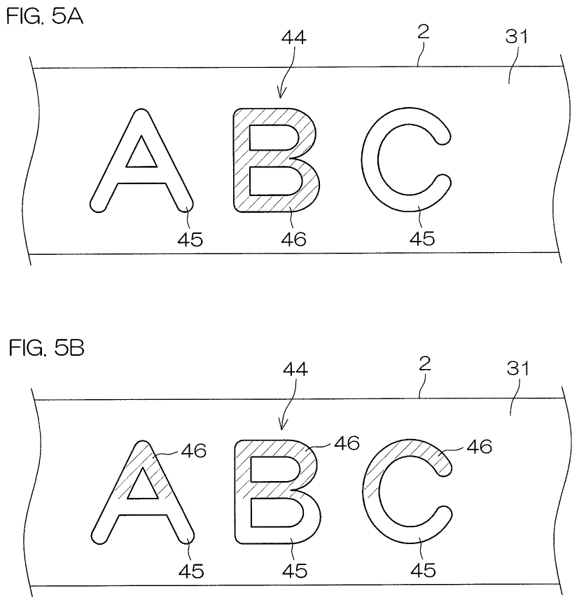

FIG. 3 is a schematic view illustrating a heating step and a cooling step of the printing device 1. FIGS. 4A and 4B are schematic views illustrating the cooling step and a transferring step of the printing device 1. FIG. 4B is an enlarged view of a main part when a transfer pattern is viewed from a direction of an arrow 4B in FIG. 4A. FIGS. 5A and 5B are views illustrating an example of a printing pattern 44 by the printing device 1. A printing step executed by the printing device 1 will be specifically described with reference to FIGS. 1 and 3 to 5A and 5B.

In order to print characters on the printer tape 2, the printer tape 2 is unrolled from the printer tape roll 10 by rotationally driving the supply roller 11, and the ink ribbon 3 is unrolled from the ink ribbon roll 12 by rotationally driving the ink ribbon winding roll 14. Consequently, as illustrated in FIGS. 1 and 3, the printer tape 2 and the ink ribbon 3 are transported toward the downstream side in a state of overlapping each other. Regarding the printer tape 2, a surface on the ink ribbon 3 side is a printing surface 31 (front surface), and a surface on the opposite side thereof is a back surface 32. Regarding the ink ribbon 3, a surface on the printer tape 2 side is an adhesive surface 33 (front surface), and a surface on the opposite side thereof is a back surface 34.

With reference to FIG. 3, the ink ribbon 3 includes a base material layer 35, a first ink layer 36 as an example of a first thermal transfer layer, and a second ink layer 37 as an example of a second thermal transfer layer. The first ink layer 36 and the second ink layer 37 are layered in this order on the front surface 38 as an example of a first surface of the base material layer 35. A surface on the opposite side to the front surface 38 of the base material layer 35 is a back surface 39 (the back surface 34 of the ink ribbon 3). The first ink layer 36 and the second ink layer 37 contain colorants having different colors. For example, the first ink layer 36 may contain a black colorant as an example of first ink, and the second ink layer 37 may contain a red colorant as an example of second ink.

The ink ribbon 3 is transported toward the thermal head 6 in a state in which the second ink layer 37 and the printer tape 2 are in contact with each other. In the thermal head 6, the heating step is executed as illustrated in FIG. 3. Specifically, the heating element 20 that generates heat due to energization is pressed against the ink ribbon 3, and thereby the heat is transmitted to the first ink layer 36 and the second ink layer 37 through the base material layer 35. A layered body of the ink ribbon 3 and the printer tape 2 is sandwiched between the thermal head 6 and the platen roller 7, and thereby the layered body is transported to the downstream side while being heated by the thermal head 6.

The heating element 20 may be controlled at the same temperature as a whole, or may be controlled at partially different temperatures. For example, as illustrated in FIG. 3, a first portion 40 of the heating element 20 may be controlled at a relatively low first heating temperature, and a second portion 41 of the heating element 20 may be controlled at a second heating temperature higher than the first heating temperature. Consequently, the ink ribbon 3 may include a first portion 42 heated at the first heating temperature and a second portion 43 heated at the second heating temperature. In the first portion 42 and the second portion 43 of the ink ribbon 3, at least a part or all of the first ink layer 36 and the second ink layer 37 is melted or softened, and comes into close contact with the printer tape 2.

With reference to FIGS. 3, 4A, and 4B, the cooling step is executed in a zone between the thermal head 6 and the ink ribbon peeling member 13. Specifically, the ink ribbon 3 thermocompression-bonded to the printer tape 2 in the heating step is naturally cooled in a zone from the thermal head 6 to the ink ribbon peeling member 13, and the temperature decreases toward a use environmental temperature of the printing device 1.

Thereafter, as illustrated in FIGS. 4A and 4B, an external force F1 is applied to the base material layer 35 and the second ink layer 37 in a direction in which the layers are separated from each other, by causing the ink ribbon peeling member 13 to selectively change only the feeding direction D2 of the ink ribbon 3. Consequently, the printer tape 2 and the ink ribbon 3 are separated from each other, and the ink ribbon 3 is wound around the ink ribbon winding roll 14. At this time, in the ink ribbon 3, the first portion 42 and the second portion 43 heated by the thermal head 6 selectively remain on the printer tape 2, and thereby the transferring step is executed. For example, in the first portion 42, peeling may occur between the base material layer 35 and a layered body including the first ink layer 36 and the second ink layer 37, and the layered body may be transferred. On the other hand, in the second portion 43, peeling may occur between the first ink layer 36 and the second ink layer 37, and the second ink layer 37 may be selectively transferred.

Consequently, the printing pattern 44 having different colors (for example, two colors including black and red) is formed on the printer tape 2. For example, as illustrated in FIG. 5A, the printing pattern 44 may have a different color for each independent character. In FIG. 5A, when viewed from the printing surface 31 side of the printer tape 2, a red pattern 45 based on the second ink layer 37 may be visually recognized on the outermost surfaces of alphabets “A” and “C,” and a black pattern 46 based on the first ink layer 36 may be visually recognized on the outermost surface of “B.” On the other hand, as illustrated in FIG. 5B, in the printing pattern 44, both the red pattern 45 and the black pattern 46 may be visually recognized for each portion of the characters.

After the ink ribbon 3 is transferred, the printer tape 2 on which the characters are recorded is taken out from the outlet 9 of the printing device 1.

### [Example of Challenge in Two-Color Printing]

In the thermal transfer printer (printing device 1), after the ink ribbon 3 is heated by the thermal head 6 according to a pattern of recording information, the ink ribbon 3 is peeled from the printer tape 2. Consequently, the ink layers 36 and 37 are selectively melted or softened according to a heating pattern to be peeled from the base material layer 35 and transferred to the printing surface 31 of the printer tape 2, and characters are recorded on the printing surface 31. Thermal transfer printing of two colors as described above is also disclosed in Patent Literatures 1 and 2 described above, but there are the following challenges.

For example, Patent Literature 1 discloses a thermal transfer sheet including a base material and a plurality of thermal transfer ink layers (for example, a first thermal transfer ink layer and a second thermal transfer ink layer) having different hues which are layered on the base material, in order to perform recording of two colors. Each of the thermal transfer ink layers is made of a thermoplastic resin, wax, or the like.

In Patent Literature 1, for example, when a relatively low energy is applied to a thermal head and thermal transfer is performed at a relatively low temperature, the first thermal transfer ink layer is softened to reduce adhesion to the base material, and the second thermal transfer ink layer is softened to generate adhesion to a front surface of a transfer target object. However, as a result of maintaining the adhesion by softening both the thermal transfer ink layers together, the entire thermal transfer ink layers, that is, the first thermal transfer ink layer and the second thermal transfer ink layer, are thermally transferred integrally to the front surface of the transfer target object. Therefore, a character recorded on the front surface of the transfer target object has, for example, a color tone of the first thermal transfer ink layer positioned on the outermost layer after transfer, for example, black.

On the other hand, when a relatively high energy is applied to the thermal head and thermal transfer is performed at a higher temperature, the first thermal transfer ink layer is further softened to increase the adhesion to the base material conversely, and the second thermal transfer ink layer is softened to generate the adhesion to the front surface of the transfer target object. During this thermal transfer, so-called reverse transfer occurs in which the first thermal transfer ink layer remains on the base material side. Therefore, only the second thermal transfer ink layer is thermally transferred selectively to the front surface of the transfer target object. Hence, the character recorded on the front surface of the transfer target object has a color tone of the second thermal transfer ink layer, for example, red.

However, a part of the first thermal transfer ink layer is transferred together with the second thermal transfer ink layer, and a range of a transfer temperature in which the color tones of the character become dusky (hereinafter may be abbreviated as a “dusky transfer range”) may be generated, between a range of a transfer temperature (the energy amount applied to the thermal head, the same being applied to the following) when both the thermal transfer ink layers are thermally transferred integrally (hereinafter may be abbreviated as a “low-temperature transfer range”) and a range of a transfer temperature when only the second thermal transfer ink layer is thermally transferred (hereinafter, may be abbreviated as a “high-temperature transfer range”).

Furthermore, in the thermal transfer sheet in which both the thermal transfer ink layers are directly layered, the dusky transfer range tends to be wide, and the low-temperature transfer range and the high-temperature transfer range tend to be narrow. In addition, heat is accumulated in the thermal head due to continuous thermal transfer printing, and the temperature of the thermal head tends to gradually increase. Therefore, it is particularly difficult to maintain the temperature of the thermal head in the low-temperature transfer range, and the color tones of the character are likely to become dusky at the time of low-temperature transfer.

The thermal transfer sheet of Patent Literature 1 may further include a peeling layer formed between the first thermal transfer ink layer and the second thermal transfer ink layer. The peeling layer is made of a colorless and transparent wax having low melt viscosity and high fluidity. The peeling layer is melted or softened during thermal transfer to promote separation of the thermal transfer ink layers. The high-temperature transfer range can be widened to a low temperature side to narrow the dusky transfer range. However, the low-temperature transfer range in which both the thermal transfer ink layers can be integrally transferred while the peeling layer is prevented from peeling tends to be conversely narrowed. In addition, since the wax has the low melt viscosity, the wax is likely to affect the surroundings. In particular, when a fine image such as a barcode is recorded, extra peeling may occur, and the sharpness of recording may deteriorate.

Patent Literature 2 discloses an ink ribbon including a base and a first ink layer and a second ink layer directly layered on the base. In Patent Literature 2, first, the ink ribbon is heated in a low-temperature transfer range, and both the ink layers are thermally transferred integrally to a front surface of the base. Thereafter, there is provided a study of re-heating at the time of peeling of the ink ribbon and reverse transferring of the first ink layer to the base side in the case of leaving only the second ink layer. However, the thermal transfer printing of Patent Literature 2 requires a printer including a special thermal head capable of performing the re-heating after the thermal transfer, and has a challenge of low versatility.

In consideration of the thermal transfer methods of Patent Literature 1 and 2, the inventors of the present application have found a plurality of challenges. At least one (first challenge) of the plurality of challenges is to provide a thermal transfer recording medium (ink ribbon) enabling a character having at least two colors to be simultaneously recorded with good sharpness.

Another one (second challenge) of the plurality of challenges is to provide a thermal transfer recording medium (ink ribbon) that does not allow color tones to become easily dusky and enables the color tones to be clearly separated into two colors even in continuous thermal transfer recording using a general-purpose thermal transfer printer for two-color recording.

Still another one (third challenge) of the plurality of challenges is to provide a thermal transfer recording medium (ink ribbon) that does not allow color tones to become easily dusky and enables the color tones to be clearly separated into two colors even in continuous thermal transfer recording and further enabling a character to be recorded with excellent sharpness without extra peeling, by using a general-purpose thermal transfer printer for two-color recording.

### [Introduction of Middle Layer 51 Including Thermoplastic Elastomer]

In order to solve the plurality of challenges, the inventors of the present application have studied and carried out introduction of a middle layer including a thermoplastic elastomer into a thermal transfer recording medium (ink ribbon), and the details thereof are as follows.

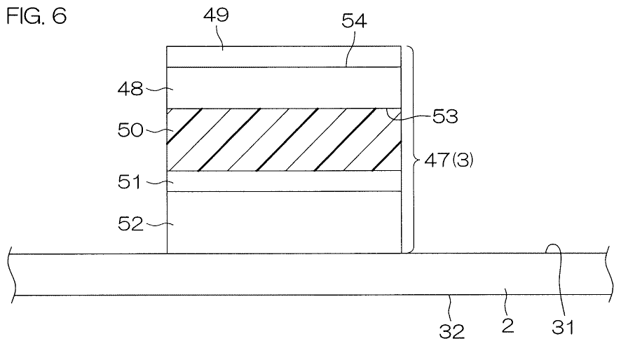

FIG. 6 is a schematic cross-sectional view illustrating a layer configuration of a thermal transfer recording medium 47 according to a preferred embodiment of the present disclosure. FIG. 6 illustrates the thermal transfer recording medium 47 in a state of adhering to the printer tape 2 as an example of the printing medium.

The thermal transfer recording medium 47 may be used as the ink ribbon 3 in the printing device 1 and the printing step illustrated in FIGS. 1 to 4A and 4B. The thermal transfer recording medium 47 includes a base material layer 48, a back surface layer 49, a first thermal transfer layer 50, a middle layer 51, and a second thermal transfer layer 52. The first thermal transfer layer 50, the middle layer 51, and the second thermal transfer layer 52 are layered in this order on a front surface 53 as an example of a first surface of the base material layer 48. A surface of the base material layer 48 opposite to the front surface 53 may be a back surface 54. The back surface layer 49 is layered on the back surface 54 of the base material layer 48. The first thermal transfer layer 50 and the second thermal transfer layer 52 may be referred to as a first ink layer and a second ink layer, respectively.

The thermal transfer recording medium 47 of the present disclosure is characterized by including the base material layer 48, and the first thermal transfer layer 50, the middle layer 51, and the second thermal transfer layer 52 which are layered in this order in direct contact with each other on the front surface 53 of the base material layer 48. The middle layer 51 includes a thermoplastic elastomer as a binder.

For example, the energy amount applied to the thermal head 6 (see FIGS. 1 and 3) may be set to be low such that thermal transfer may be performed at a relatively low temperature in the thermal transfer recording medium 47. In this case, the first thermal transfer layer 50 is softened, and the adhesion to the base material layer 48 decreases. On the other hand, the second thermal transfer layer 52 is softened, and the adhesion to the printing surface 31 of the printer tape 2 is produced. In addition, affinity between the middle layer 51 and both the thermal transfer layers 50 and 52 is enhanced, and the adhesion of both the thermal transfer layers 50 and 52 to the middle layer 51 is improved. Further, the middle layer 51 including the thermoplastic elastomer has a relatively high melt viscosity as compared with the wax or the like forming the peeling layer as in Patent Literature 1. The middle layer 51 maintains the adhesion to the first thermal transfer layer 50 and the second thermal transfer layer 52 due to rubber-like elasticity of the middle layer. As a result, all of the thermal transfer layers, that is, the first thermal transfer layer 50, the middle layer 51, and the second thermal transfer layer 52, are thermally transferred integrally to the printing surface 31 of the printer tape 2. A character recorded on the printing surface 31 of the printer tape 2 has a color tone of the first thermal transfer layer 50 located on the outermost layer after transfer, for example, black.

On the other hand, the energy amount applied to the thermal head 6 may be set to be high such that the thermal transfer recording medium 47 may be thermally transferred at a higher temperature. In this case, the first thermal transfer layer 50 is further softened to increase the adhesion to the base material layer 48, and the second thermal transfer layer 52 has the adhesion to the printing surface 31 of the printer tape 2. In addition, the adhesion of the first thermal transfer layer 50 to the middle layer 51 increases, and exceeds the adhesion between the second thermal transfer layer 52 and the middle layer 51. During the thermal transfer, only the second thermal transfer layer 52 is thermally transferred to the printing surface 31 of the printer tape 2 while reverse transfer in which the first thermal transfer layer 50 and the middle layer 51 remain on the base material layer 48 side occurs. Hence, the character recorded on the printing surface 31 of the printer tape 2 have the color tone of the second thermal transfer layer 52, for example, red. As a result, for example, a pattern having two colors including black and red can be recorded using the general-purpose thermal transfer printer for two-color recording.

In addition, since the thermoplastic elastomer included in the middle layer 51 has a melt viscosity higher than that of the wax or the like as described above, the low-temperature transfer range in which both the thermal transfer layers 50 and 52 can be integrally transferred can be widened to a high temperature side to narrow the dusky transfer range. Furthermore, characteristics such as the rubber-like elasticity and the adhesion of the middle layer 51 including the thermoplastic elastomer having the high melt viscosity have temperature dependency lower than that of both the thermal transfer layers 50 and 52 and the peeling layer. Therefore, even if the thermal transfer recording is continuously performed and the temperature of the thermal head 6 gradually rises, it is also possible to prevent the character from having a dusky color tone.

Hence, according to the present disclosure, color tones are not likely to become dusky and can be clearly separated into two colors even in the continuous thermal transfer recording, and a character can be recorded with excellent sharpness without extra peeling, by using a general-purpose thermal transfer printer for two-color recording.

Hereinafter, specific compositions, physical properties, and the like of the base material layer 48, the back surface layer 49, the first thermal transfer layer 50, the middle layer 51, and the second thermal transfer layer 52 included in the thermal transfer recording medium 47 will be described in detail.

### (1) Base Material Layer 48

Examples of the base material layer 48 include a film of a resin such as polysulfone, polystyrene, polyamide, polyimide, polycarbonate, polypropylene, polyester, or triacetate, condenser paper, tissue paper such as glassine paper, cellophane, and the like. Of these materials, a film of polyester such as polyethylene terephthalate (PET) or polyethylene naphthalate is preferable from the viewpoint of mechanical strength, dimensional stability, heat treatment resistance, price, or the like. A thickness of the base material layer 48 can be arbitrarily set according to, for example, specifications of a thermal transfer printer. For example, the thickness of the base material layer 48 is 1 μm or more, and preferably 2 μm or more. For example, the thickness of the base material layer 48 is 10 μm or less, and preferably 8 μm or less. For example, the thickness of the base material layer 48 is 1 μm or more and 10 μm or less, and preferably 2 μm or more and 8 μm or less.

### (2) Back Surface Layer 49

The back surface layer 49 improves heat resistance, slippage, abrasion resistance, or the like of the back surface 54 of the base material layer 48 which is brought into contact with the thermal head 6. Examples of the back surface layer 49 include a silicone resin, a fluororesin, a silicone-fluorine copolymer resin, a nitrocellulose resin, a silicone-modified urethane resin, a silicone-modified acrylic resin, and the like. The back surface layer 49 may include a lubricant, as necessary.

The back surface layer 49 can be formed, for example, by applying, on the back surface 54 of the base material layer 48, a coating material obtained by dissolving or dispersing the resin or the like in any solvent, and then drying the coating material. A thickness of the back surface layer 49 can be arbitrarily set according to, for example, specifications of a thermal transfer printer. The thickness of the back surface layer 49 can be adjusted by an application amount of the back surface layer 49.

For example, the application amount of the back surface layer 49 is 0.05 g/m² or more, and preferably 0.1 g/m² or more in terms of a solid content per unit area. For example, the application amount of the back surface layer 49 is 0.5 g/m² or less, and preferably 0.4 g/m² or less in terms of the solid content per unit area. For example, the application amount of the back surface layer 49 is 0.05 g/m² or more and 0.5 g/m² or less, and preferably 0.1 g/m² or more and 0.4 g/m² or less in terms of the solid content per unit area. A specific thickness of the back surface layer 49 is, for example, 0.05 μm or more, and preferably 0.1 μm or more. The thickness of the back surface layer 49 is, for example, 0.5 μm or less, and preferably 0.4 μm or less. The thickness of the back surface layer 49 is, for example, 0.05 μm or more and 0.5 μm or less, and may be preferably 0.1 μm or more and 0.4 μm or less.

### (3) First Thermal Transfer Layer 50

The first thermal transfer layer 50 can be made of, for example, any thermoplastic resin. The first thermal transfer layer 50 is preferably formed using an epoxy resin as the thermoplastic resin in consideration of improving the affinity and the adhesion to the base material layer 48 and the middle layer 51. The epoxy resin is excellent in affinity and adhesion to the thermoplastic elastomer included in the base material layer 48 and the middle layer 51 formed by a film of polyester such as PET. The first thermal transfer layer 50 can be formed using, as a thermoplastic resin, an epoxy resin in a (excluding) state in which a curing agent is not blended.

Examples of the epoxy resin include a bisphenol A epoxy resin, a bisphenol F epoxy resin, a phenol novolac epoxy resin, a cresol novolac epoxy resin, an alicyclic epoxy resin, a hydrogenated bisphenol A epoxy resin, a hydrogenated bisphenol AD epoxy resin, an aliphatic epoxy resin such as propylene glycol glycoxyl ether or pentaerythritol polyglycidyl ether, an epoxy resin obtained from aliphatic or aromatic amine and epichlorohydrin, an epoxy resin obtained from aliphatic or aromatic carboxylic acid and epichlorohydrin, a heterocyclic epoxy resin, a spirocyclic epoxy resin, an epoxy-modified resin, a brominated epoxy resin, and the like. Specific examples of the epoxy resin are not particularly limited, and include the following various epoxy resins. These epoxy resins can be used individually or in combination of two or more kinds thereof.

Examples thereof include, in the JER (registered trademark) series of epoxy resins manufactured by Mitsubishi Chemical Group, basic solid types 1001 [softening point (ring-and-ball method): 64° C., number average molecular weight Mn: about 900], 1002 [softening point (ring-and-ball method): 78° C., number average molecular weight Mn: about 1,200], 1003 [softening point (ring-and-ball method): 89° C., number average molecular weight Mn: about 1,300], 1055 [softening point (ring-and-ball method): 93° C., number average molecular weight Mn: about 1,600], 1004 [softening point (ring-and-ball method): 97° C., number average molecular weight Mn: about 1,650], 1004AF [softening point (ring-and-ball method): 97° C., number average molecular weight Mn: about 1,650], 1007 [softening point (ring-and-ball method): 128° C., number average molecular weight Mn: about 2,900], 1009 [softening point (ring-and-ball method): 144° C., number average molecular weight Mn: about 3,800], 1010 [number average molecular weight Mn: about 5,500], 1003F [softening point (ring-and-ball method): 96° C.], 1004F [softening point (ring-and-ball method): 103° C.], 1005F, 1009F [softening point (ring-and-ball method): 144° C.], 1004FS [softening point (ring-and-ball method): 100° C.], 1006FS [softening point (ring-and-ball method): 112° C.], and 1007FS [softening point (ring-and-ball method): 124° C.].

The softening point of the epoxy resin used for the first thermal transfer layer 50 is, for example, 95° C. or higher, preferably 110° C. or higher, and more preferably 125° C. or higher. When the softening point falls within this range, it is possible to prevent a high adhesive force from being generated between the first thermal transfer layer 50 and the base material layer 48 at a relatively low temperature during low-temperature transfer. Since the low-temperature transfer range of the first thermal transfer layer 50 can be sufficiently widened toward a high temperature side, it is possible to prevent the color tones from becoming dusky even in the continuous thermal transfer recording.

The first thermal transfer layer 50 may contain an adhesive in addition to the epoxy resin. The affinity and the adhesion to the base material layer 48 and the middle layer 51 can be further improved with the adhesive contained in the first heat transfer layer. Examples of the adhesive include a rubber-based adhesive, an acrylic adhesive, a silicone-based adhesive, a vinyl alkyl ether-based adhesive, a polyvinyl alcohol-based adhesive, a polyvinylpyrrolidone-based adhesive, a polyacrylamide-based adhesives, a cellulose-based adhesive, and the like.

In consideration of improving affinity and compatibility with the epoxy resin and the affinity and the adhesion to the base material layer 48 and the middle layer 51, the acrylic adhesive is preferable as the adhesive. Specific examples of the acrylic adhesive are not particularly limited, and include the following various acrylic adhesives. These acrylic adhesives can be used individually or in combination of two or more kinds thereof.

Examples thereof include, in the Oribain (registered trademark) BPS (solvent-based) series manufactured by TOYOCHEM CO., LTD., BPS 1109 (non-volatile content: 39.5 mass %), BPS 3156D (non-volatile content: 34 mass %), BPS 4429-4 (non-volatile content: 45 mass %), BPS 4849-40 (non-volatile content: 40 mass %), BPS 5160 (non-volatile content: 33 mass %), BPS 5213K (non-volatile content: 35 mass %), BPS 5215K (non-volatile content: 39 mass %), BPS 5227-1 (non-volatile content: 41.5 mass %), BPS 5296 (non-volatile content: 37 mass %), BPS 5330 (non-volatile content: 40 mass %), BPS 5375 (non-volatile content: 45 mass %), BPS 5448 (non-volatile content: 40 mass %), BPS 5513 (non-volatile content: 44.5 mass %), BPS 5565K (non-volatile content: 45 mass %), BPS 5669K (non-volatile content: 46 mass %), BPS 5762K (non-volatile content: 45.5 mass %), BPS 5896 (non-volatile content: 37 mass %), BPS 5978 (non-volatile content: 35 mass %), BPS 6074HTF (non-volatile content: 52 mass %), BPS 6080TFK (non-volatile content: 45 mass %), BPS 6130TF (non-volatile content: 45.5 mass %), BPS 6153K (non-volatile content: 25 mass %), BPS 6163 (non-volatile content: 37 mass %), BPS 6231 (non-volatile content: 56 mass %), BPS 6421 (non-volatile content: 47 mass %), BPS 6430 (non-volatile content: 33 mass %), BPS 6574 (non-volatile content: 57 mass %), BPS 8170 (non-volatile content: 36.5 mass %), and BPS HS-1 (non-volatile content: 40 mass %).

Further, Examples thereof include, of the solvent-based adhesives (peeling-type) manufactured by LION SPECIALTY CHEMICALS CO., LTD., AS-325 (solid content concentration: 45 mass %), AS-375 (solid content concentration: 45 mass %), AS-409 (solid content concentration: 45 mass %), AS-417 (solid content concentration: 45 mass %), AS-425 (solid content concentration: 45 mass %), AS-455 (solid content concentration: 45 mass %), AS-665 (solid content concentration: 40 mass %), AS-1107 (solid content concentration: 43 mass %), and AS-4005 (solid content concentration: 45 mass %).

The acrylic adhesive used in the first thermal transfer layer 50 may be used in combination with a tackifier. This is because, for example, it is possible to increase the sharpness of the first thermal transfer layer 50, prevent the extra peeling, and improve the sharpness of the character to be recorded. Examples of the tackifier include ester gum, terpene phenolic resin, rosin ester, and the like. Specific examples of the tackifier are not particularly limited, and include the following various tackifiers. These tackifiers can be used individually or in combination of two or more kinds thereof.

Examples thereof include, of the terpene phenolic resins in YS POLYSTER series manufactured by YASUHARA CHEMICAL Co., Ltd., U130 (softening point: 130±5° C.), U115 (softening point: 115±5° C.), T160 (softening point: 160±5° C.), T145 (softening point: 145±5° C.), T130 (softening point: 130±5° C.), T115 (softening point: 115±5° C.), T100 (softening point: 100±5° C.), T80 (softening point: 80±5° C.), S145 (softening point: 145±5° C.), G150 (softening point: 150±5° C.), G125 (softening point: 125±5° C.), N125 (softening point: 125±5° C.), K125 (softening point: 125±5° C.), and TH130 (softening point: 130±5° C.).

Further, examples thereof include, of the ester gums manufactured by Arakawa Chemical Industries, Ltd., AA-G [softening point (ring-and-ball method): 82 to 88° C.], AA-L [softening point (ring-and-ball method): 82 to 88° C.], AA-V [softening point (ring-and-ball method): 82 to 95° C.], 105 [softening point (ring-and-ball method): 100 to 110° C.], AT [viscosity: 20,000 to 40,000 mPa·s], H [softening point (ring-and-ball method): 68 to 75° C.], and HP [softening point (ring-and-ball method): 80° C. or higher].

Furthermore, examples thereof include, of the rosin esters in the PENSEL (registered trademark) series manufactured by Arakawa Chemical Industries, Ltd., GA-100 [softening point (ring-and-ball method): 100 to 110° C.], AZ [softening point (ring-and-ball method): 950 to 105° C.], C [softening point (ring-and-ball method): 117 to 127° C.], D-125 [softening point (ring-and-ball method): 120 to 130° C.], D-135 [softening point (ring-and-ball method): 130 to 140° C.], D-160 [softening point (ring-and-ball method): 150 to 165° C.], and KK [softening point (ring-and-ball method): 165° C. or higher].

The softening point of the tackifier used in the first thermal transfer layer 50 is, for example, 60° C. or higher, and preferably 120° C. or lower. When the softening point falls within this range, the first thermal transfer layer 50 and the middle layer 51 can be well reversely transferred to the base material layer 48 side at the time of high-temperature transfer. Since the high-temperature transfer range of the first thermal transfer layer 50 can be sufficiently widened to a low temperature side, it is possible to prevent the color tones from becoming dusky.

The first thermal transfer layer 50 may contain any colorant. As the colorant, one or more kinds of various colorants corresponding to the color tones of the first thermal transfer layer 50 can be used. For example, pigments may be used as the colorants. In consideration of improvement or the like in weather resistance of a character, the pigments are preferable as the colorants used in the first thermal transfer layer 50. For example, carbon black is preferable as a pigment for coloring the first thermal transfer layer 50 into black. Specific examples of the carbon black are not particularly limited, and include the following various carbon blacks. These carbon blacks can be used individually or in combination of two or more kinds thereof.

Examples thereof include MA77 in powder form [LFF, DBP absorption number: 68 cm³/100 g], MA7 in powder form [LFF, DBP absorption number: 66 cm³/100 g], MA7 in bead form [LFF, DBP absorption number: 65 cm³/100 g], MA8 in powder form [LFF, DBP absorption number: 57 cm³/100 g], MA8 in bead form [LFF, DBP absorption number: 51 cm³/100 g], MA11 in powder form [LFF, DBP absorption number: 64 cm³/100 g], MA100 in powder form [LFF, DBP absorption number: 100 cm³/100 g], MA100 in bead form [LFF, DBP absorption number: 95 cm³/100 g], MA100R in powder form [LFF, DBP absorption number: 100 cm³/100 g], MA100R in bead form [LFF, DBP absorption number: 95 cm³/100 g], MA100S in powder form [LFF, DBP absorption number: 100 cm³/100 g], MA230 in powder form [LFF, DBP absorption number: 113 cm³/100 g], MA220 in powder form [LFF, DBP absorption number: 93 cm³/100 g], and MA14 in powder form [LFF, DBP absorption number: 73 cm³/100 g] manufactured by Mitsubishi Chemical Group.

Further, examples thereof include #3030B (furnace method, DBP absorption number: 130 cm³/100 g), #3040B (furnace method, DBP absorption number: 114 cm³/100 g), #3050B (furnace method, DBP absorption number: 175 cm³/100 g), #3230B (furnace method, DBP absorption number: 140 cm³/100 g), #3350B (furnace method, DBP absorption number: 164 cm³/100 g), and #3400B (furnace method, DBP absorption number: 175 cm³/100 g) manufactured by Mitsubishi Chemical Group.

Furthermore, examples thereof include, in the TOKABLACK (registered trademark) series manufactured by Tokai Carbon Co., Ltd., #5500 (furnace method, DBP absorption number: 155 cm³/100 g), #4500 (furnace method, DBP absorption number: 168 cm³/100 g), #4400 (furnace method, DBP absorption number: 135 cm³/100 g), and #4300 (furnace method, DBP absorption number: 142 cm³/100 g).

Examples thereof include, in the PRINTEX (registered trademark) series manufactured by ORION ENGINEERED CARBONS, L (furnace method, DBP absorption number: 120 cm³/100 g) and L6 (furnace method, DBP absorption number: 126 cm³/100 g).

Examples thereof include, in the CONDUCTEX (registered trademark) series manufactured by Birla Carbon, 975 (furnace method, 170 cm³/100 g) and SC (furnace method, 115 cm³/100 g).

Examples thereof include, XC72 (furnace method, DBP absorption number: 174 cm³/100 g) and 9A32 (furnace method, DBP absorption number: 114 cm³/100 g) in the VULCAN (registered trademark) series manufactured by Cabot Corporation, and 3700 (furnace method, DBP absorption number: 111 cm³/100 g) in the BLACK PEARLS series manufactured by Cabot Corporation.

Examples thereof include, in the DENKA BLACK (registered trademark) series manufactured by Denka Company Limited, DENKA BLACK bead-form product (acetylene process, DBP absorption number: 160 cm³/100 g), FX-35 (acetylene process, DBP absorption number: 220 cm³/100 g), and HS-100 (acetylene process, DBP absorption number: 140 cm³/100 g).

Examples thereof include, in the KETJENBLACK (registered trademark) series manufactured by LION SPECIALTY CHEMICALS CO., LTD., EC300J (gasification process, DBP absorption number: 360 cm³/100 g) and EC600DJ (gasification process, DBP absorption number: 495 cm³/100 g).

Ratios of components in the first thermal transfer layer 50 are not particularly limited. The ratio of the acrylic adhesive with respect to 100 parts by mass of the epoxy resin is, for example, 30 parts by mass or more, and preferably 40 parts by mass or more. The ratio of the acrylic adhesive with respect to 100 parts by mass of the epoxy resin is, for example, 150 parts by mass or less, and preferably 100 parts by mass or less. The ratio of the acrylic adhesive with respect to 100 parts by mass of the epoxy resin is, for example, 30 parts by mass or more and 150 parts by mass or less, and preferably 40 parts by mass or more and 100 parts by mass or less.

The ratio of the tackifier with respect to 100 parts by mass of the epoxy resin is, for example, 3 parts by mass or more, and preferably 5 parts by mass or more. The ratio of the tackifier with respect to 100 parts by mass of the epoxy resin is, for example, 150 parts by mass or less, and preferably 100 parts by mass or less. The ratio of the tackifier with respect to 100 parts by mass of the epoxy resin is, for example, 3 parts by mass or more and 150 parts by mass or less, and preferably 5 parts by mass or more and 100 parts by mass or less.

A ratio of the colorant such as carbon black with respect to 100 parts by mass of the epoxy resin is, for example, 100 parts by mass or more, and preferably 130 parts by mass or more. The ratio of the colorant with respect to 100 parts by mass of the epoxy resin is, for example, 230 parts by mass or less, and preferably 200 parts by mass or less. The ratio of the colorant with respect to 100 parts by mass of the epoxy resin is, for example, 100 parts by mass or more and 230 parts by mass or less, and preferably 130 parts by mass or more and 200 parts by mass or less.

Note that, of the components contained in the first thermal transfer layer 50, a blending amount of a component which is supplied in a liquid form dissolved or dispersed in any solvent may be adjusted so that a ratio of an active component falls within the above range (the same being applied to the following).

The first thermal transfer layer 50 can be formed, for example, by applying, onto the front surface 53 of the base material layer 48 directly or through any release layer, a coating material obtained by dissolving or dispersing each of the above-described components in any solvent, and then drying the coating material. In the present disclosure, as illustrated in FIGS. 5A and 5B, the characters to be recorded on the printer tape 2 are color-coded. In order to perform this color-coding, it is preferable that the first thermal transfer layer 50 is directly formed on the front surface 53 of the base material layer 48 without the release layer, in consideration of adjustment of the adhesion between the first thermal transfer layer 50 and the base material layer 48 or each of other layers.

A thickness of the first thermal transfer layer 50 can be arbitrarily set according to, for example, specifications of the thermal transfer printer. The thickness of the first thermal transfer layer 50 can be adjusted by an application amount of the first thermal transfer layer 50.

For example, the application amount of the first thermal transfer layer 50 is 0.1 g/m² or more, and preferably 0.5 g/m² or more in terms of a solid content per unit area. For example, the application amount of the first thermal transfer layer 50 is 3.0 g/m² or less, and preferably 2.5 g/m² or less in terms of the solid content per unit area. For example, the application amount of the first thermal transfer layer 50 is 0.1 g/m² or more and 3.0 g/m² or less, and preferably 0.5 g/m² or more and 2.5 g/m² or less in terms of the solid content per unit area.

A specific thickness of the first thermal transfer layer 50 (before printing) is, for example, 0.05 μm or more, and preferably 0.5 μm or more. The thickness of the first thermal transfer layer 50 is, for example, 3.0 μm or less, and preferably 2.5 μm or less. The thickness of the first thermal transfer layer 50 is, for example, 0.05 μm or more and 3.0 μm or less, and may be preferably 0.5 μm or more and 2.5 μm or less. The thickness of the first thermal transfer layer 50 can be checked based on, for example, a scanning electron microscope (SEM) image, a transmission electron microscope (TEM) image, or the like of the thermal transfer recording medium 47.

### (4) Middle Layer 51

The middle layer 51 includes a thermoplastic elastomer as described above. In particular, the middle layer 51 is preferably formed only by the thermoplastic elastomer. The thermoplastic elastomer forming the middle layer 51 preferably includes at least one of a styrene-based thermoplastic elastomer and an acetate ester-based thermoplastic elastomer.

Examples of the styrene-based thermoplastic elastomer include a styrene-butadiene-styrene block copolymer (SBS), a styrene-ethylene-butene-styrene block copolymer (SEBS), a styrene-ethylene-propylene-styrene block copolymer (SEPS), a styrene-ethylene/ethylene-propylene-styrene block copolymer (SEEPS), a styrene-isoprene-styrene block copolymer (SIS), and the like. Examples of the acetate ester-based thermoplastic elastomer include an ethylene-vinyl acetate copolymer (EVA) and the like.

A percentage styrene content in the thermoplastic elastomer included in the middle layer 51 is, for example, 10 mass % or more and 70 mass % or less, and preferably 15 mass % or more and 50 mass % or less. If the percentage styrene content is too high, the rubber-like elasticity of the middle layer 51 decreases, and there is a case where it is not possible to maintain the adhesion to the first thermal transfer layer 50 and the second thermal transfer layer 52 at the time of low-temperature transfer, or a case where the color tones of the characters become dusky. If the percentage styrene content is too low, the rubber-like elasticity of the middle layer 51 increases too high, so that it is not possible for the second thermal transfer layer 52 to be peeled off at the time of high-temperature transfer, and the colors of the character may become dusky.

The thermoplastic elastomer included in the middle layer 51 has a Melt Mass-Flow Rate (hereinafter simply abbreviated as “MFR”) of, for example, 1000 g/10 min or less, and preferably 400 g/10 min or less. The MFR may be, for example, an MFR at a temperature of 190° C. and under a load of 2.16 kg, which is determined in accordance with a measurement method defined in ISO 1133-1:2011. Hereinafter, unless otherwise specified, conditions for measuring the MFR are a temperature of 190° C. and a load of 2.16 kg.

The thermoplastic elastomer having an MFR of more than 400 g/10 min tends to have too high affinity to the second thermal transfer layer 52. Therefore, there is a case where it is not possible to peel the second thermal transfer layer 52 at the time of high-temperature transfer, and the colors of the characters become dusky. In addition, the entire thermal transfer recording medium 47, that is, the base material layer 48, the first thermal transfer layer 50, the middle layer 51, and the second thermal transfer layer 52, may be attached to the printing surface 31 of the printer tape 2. A thermoplastic elastomer having an MFR of more than 400 g/10 min has a low melt viscosity and high fluidity, and thus may fail to maintain the adhesion to the first thermal transfer layer 50 and the second thermal transfer layer 52 at the time of low-temperature transfer, or may result in dusky color tone of the characters.

In this respect, when the thermoplastic elastomer has an MFR of 400 g/10 min or less, it is possible to prevent problems that may arise when the thermoplastic elastomer having an MFR exceeding 400 g/10 min is used. Accordingly, even if the thermal transfer recording is continuously performed, the color tones do not easily become dusky and are clearly separated into two colors on the printing surface 31 of the printer tape 2, and furthermore, the characters can be recorded with excellent sharpness without extra peeling. In consideration of further improving these effects, the MFR of the thermoplastic elastomer is preferably 2.5 g/10 min or less, and particularly 2.3 g/10 min or less even within the above range.

The lower limit of the MFR is not particularly limited, and thermoplastic elastomers having a measurement result of “No Flow (not flowing)” at a temperature of 190° C. under a load of 2.16 kg can also be used. Specific examples of the thermoplastic elastomers are not particularly limited, and include the following various thermoplastic elastomers. These thermoplastic elastomers can be used individually or in combination of two or more kinds thereof.

Examples thereof include, of SEBSs in the Tuftec (registered trademark) series manufactured by Asahi Kasei Corporation, H1521 [MFR: 2.3 g/10 min], H1051 [MFR: less than 0.8 g/10 min], H1052 [MFR: less than 13.0 g/10 min], H1272 [MFR: No Flow], P1083 [MFR: 3.0 g/10 min], P1500 [MFR: 4.0 g/10 min], P5051 [MFR: 3.0 g/10 min], and P2000 [MFR: 3.0 g/10 min].

Further, Examples thereof include, of SBSs in the Tufprene (registered trademark) series manufactured by Asahi Kasei Corporation, A [MFR: 2.6 g/10 min], 125 [MFR: 4.5 g/10 min], and 126S [MFR: 4.5 g/10 min].

Examples thereof include, of SBSs in the Asaprene (registered trademark) T series manufactured by Asahi Kasei Corporation, T-411 [MFR: No Flow], T-432 [MFR: No Flow], T-437 [MFR: No Flow], T-438 [MFR: No Flow], and T-439 [MFR: No Flow].

Examples thereof include, of SEPSs in the SEPTON (registered trademark) series manufactured by KURARAY CO., LTD., 2002 [MFR: 70 g/10 min], 2004F [MFR: 5 g/10 min], 2005 [MFR: No Flow], 2006 [MFR: No Flow], 2063 [MFR: 7 g/10 min], and 2104 [MFR: 0.4 g/10 min]. The measurement conditions of the MFR of all of these SEPSs are at a temperature of 230° C. and under a load of 2.16 kg.

Examples thereof include, of SEEPSs in the SEPTON (registered trademark) series manufactured by KURARAY CO., LTD., 4033 [MFR: <0.1 g/10 min], 4044 [MFR: No Flow], 4055 [MFR: No Flow], 4077 [MFR: No Flow], and 4099 [MFR: No Flow]. The measurement conditions of the MFR of all of these SEEPSs are at a temperature of 230° C. and under a load of 2.16 kg.

Examples thereof include, of vinyl SISs in the HYBRAR (registered trademark) series manufactured by KURARAY CO., LTD., 5125 [MFR: 4 g/10 min] and 5127 [MFR: 5/10 min].

Examples thereof include, of EVAs in the Ultrathene (registered trademark) series manufactured by Tosoh Corporation, 514R [MFR: 0.41 g/10 min], 515 [MFR: 2.5 g/10 min], 510 [MFR: 2.5 g/10 min], 51° F. [MFR: 2.5 g/10 min], 520F [MFR: 2.0 g/10 min], 540 [MFR: 3.0 g/10 min], 540F [MFR: 3.0 g/10 min], 537 [MFR: 8.5 g/10 min], 537L [MFR: 8.5 g/10 min], 537S-2 [MFR: 8.5 g/10 min], 541 [MFR: 9.0 g/10 min], 541L [MFR: 9.0 g/10 min], 530 [MFR: 75 g/10 min], 526 [MFR: 25 g/10 min], 630 [MFR: 1.5 g/10 min], 631 [MFR: 1.5 g/10 min], 636 [MFR: 2.5 g/10 min], 625 [MFR: 14 g/10 min], 626 [MFR: 3.0 g/10 min], 627 [MFR: 0.8 g/10 min], 633 [MFR: 20 g/10 min], 635 [MFR: 2.4 g/10 min], 640 [MFR: 2.8 g/10 min], 634 [MFR: 4.3 g/10 min], 680 [MFR: 160 g/10 min], 681 [MFR: 350 g/10 min], 751 [MFR: 5.7 g/10 min], 710 [MFR: 18 g/10 min], 720 [MFR: 150 g/10 min], 722 [MFR: 400 g/10 min], 750 [MFR: 30 g/10 min], 752 [MFR: 60 g/10 min], and 760 [MFR: 70 g/10 min].

The middle layer 51 can be formed, for example, by applying, on the first thermal transfer layer 50, a coating material obtained by dissolving or dispersing a forming material for the middle layer 51 including at least a thermoplastic elastomer in any solvent, and then drying the coating material.

A thickness of the middle layer 51 can be arbitrarily set according to, for example, specifications of the thermal transfer printer. The thickness of the middle layer 51 can be adjusted by an application amount of the middle layer 51. For example, the application amount of the middle layer 51 is 0.1 g/m² or more, and preferably 0.2 g/m² or more in terms of a solid content per unit area. For example, the application amount of the middle layer 51 is 2.0 g/m² or less, and preferably 1.5 g/m² or less in terms of the solid content per unit area. For example, the application amount of the middle layer 51 is 0.1 g/m² or more and 2.0 g/m² or less, and preferably 0.2 g/m² or more and 1.5 g/m² or less in terms of the solid content per unit area.

A specific thickness of the middle layer 51 (before printing) is, for example, 0.05 μm or more, and preferably 0.2 μm or more. The thickness of the middle layer 51 is, for example, 2.0 μm or less, and preferably 1.5 μm or less. The thickness of the middle layer 51 is, for example, 0.05 μm or more and 2.0 μm or less, and may be preferably 0.2 μm or more and 1.5 μm or less. The thickness of the middle layer 51 can be checked based on, for example, the scanning electron microscope (SEM) image, the transmission electron microscope (TEM) image, or the like of the thermal transfer recording medium 47.

Note that an error in the thickness of the middle layer 51 may be found depending on a measurement position due to the application accuracy limit. The application amount and the thickness of the middle layer 51 may be values including the error. For example, the middle layer 51 formed with an application amount of 0.2 g/m² may have a region having a thickness in a case of forming the middle layer with an application amount of 0.1 g/m² depending on the measurement position.

### (5) Second Thermal Transfer Layer 52

The second thermal transfer layer 52 can be made of, for example, any thermoplastic resin. Examples of the thermoplastic resin used for the second thermal transfer layer 52 include an epoxy resin, a polyester resin, a polyolefin resin, and the like. The thermoplastic resin can be appropriately selected according to a forming material or the like for the printer tape 2. In a case where the first thermal transfer layer 50 is made of the epoxy resin, it is preferable that the second thermal transfer layer 52 is also made of the epoxy resin similarly.

The adhesion of the first thermal transfer layer 50 to the base material layer 48 and the middle layer 51 and the adhesion of the second thermal transfer layer 52 to the printer tape 2 can be balanced by making the second thermal transfer layer 52 of the epoxy resin. Consequently, at the time of high-temperature transfer, both the first thermal transfer layer 50 and the middle layer 51 can be favorably separated toward the base material layer 48 side, and the second thermal transfer layer 52 can be favorably separated toward the printer tape 2 side. Since the high-temperature transfer range can be widened to the low temperature side, the effect of preventing the color tone from becoming dusky can be further improved. Examples of the epoxy resin include various epoxy resins exemplified as the epoxy resin of the first thermal transfer layer 50. These epoxy resins can be used individually or in combination of two or more kinds thereof.

The second thermal transfer layer 52 may contain wax in addition to the thermoplastic resin. The wax contained in the second thermal transfer layer enables both the first thermal transfer layer 50 and the middle layer 51 to be favorably separated toward the base material layer 48 side and enables the second thermal transfer layer 52 to be favorably separated toward the printer tape 2 side at the time of high-temperature transfer. Therefore, since the high-temperature transfer range can be widened to the low temperature side, the effect of preventing the color tone from becoming dusky can be further improved.

As the wax, any wax having affinity with or compatibility with a thermoplastic resin such as an epoxy resin can be used. For example, natural wax such as carnauba wax, paraffin wax, and microcrystalline wax, and synthetic wax such as Fischer Tropsch wax can be used. Specific examples of the wax are not particularly limited, and include carnauba wax No. 1 flake, No. 2 Flake, No. 3 Flake, No. 1 Powder and No. 2 Powder (melting points of all the products: 80 to 86° C.) manufactured by TOYOCHEM CO., LTD., EMUSTAR-1155 (melting point: 69° C.), EMUSTAR-0135 (melting point: 60° C.), EMUSTAR-0136 (melting point: 60° C.) and the like which are paraffin wax products manufactured by NIPPON SEIRO CO., LTD., EMUSTAR-0001 (melting point: 84° C.), EMUSTAR-042X (melting point: 84° C.) and the like which are microcrystalline wax products manufactured by NIPPON SEIRO CO., LTD., FNP-0090 (condensation point: 90° C.), SX80 (condensation point: 83° C.), FT-0165 (melting point: 73° C.), FT-0070 (melting point: 72° C.), and the like which are Fischer Tropsch wax products manufactured by NIPPON SEIRO CO., LTD. These wax products can be used individually or in combination of two or more kinds thereof.

The second thermal transfer layer 52 may contain any colorant. As the colorant, one or more kinds of various colorants corresponding to the color tone of the second thermal transfer layer 52 can be used. For example, pigments may be used as the colorants. In consideration of improvement or the like in weather resistance of a character, the pigments are preferable as the colorants used in the second thermal transfer layer 52. Examples of the pigments for coloring the second thermal transfer layer 52 into red include the following various red pigments. These red pigments can be used individually or in combination of two or more kinds thereof.

Examples thereof include C.I. Pigment Red 5, 7, 9, 12, 48 (Ca), 48 (Mn), 49, 52, 53, 53:1, 57 (Ca), 57:1, 97, 112, 122, 123, 149, 168, 177, 178, 179, 184, 202, 206, 207, 209, 242, 254, and 255.

Ratios of components in the second thermal transfer layer 52 are not particularly limited. A ratio of the wax with respect to 100 parts by mass of the epoxy resin is, for example, 3 parts by mass or more, and preferably 5 parts by mass or more. The ratio of the wax with respect to 100 parts by mass of the epoxy resin is, for example, 11 parts by mass or less, and preferably 9 parts by mass or less. The ratio of the wax with respect to 100 parts by mass of the epoxy resin is, for example, 3 parts by mass or more and 11 parts by mass or less, and preferably 5 parts by mass or more and 9 parts by mass or less.

A ratio of the colorant such as a red pigment with respect to 100 parts by mass of the epoxy resin is, for example, 70 parts by mass or more, and preferably 80 parts by mass or more. The ratio of the colorant such as the red pigment with respect to 100 parts by mass of the epoxy resin is, for example, 140 parts by mass or less, and preferably 120 parts by mass or less. The ratio of the colorant such as the red pigment with respect to 100 parts by mass of the epoxy resin is, for example, 70 parts by mass or more and 140 parts by mass or less, and preferably 80 parts by mass or more and 120 parts by mass or less.

The second thermal transfer layer 52 can be formed, for example, by applying, on the middle layer 51, a coating material obtained by dissolving or dispersing the above components in any solvent and then drying the coating material.

A thickness of the second thermal transfer layer 52 can be arbitrarily set according to, for example, specifications of the thermal transfer printer. The thickness of the second thermal transfer layer 52 can be adjusted by an application amount of the second thermal transfer layer 52. For example, the application amount of the second thermal transfer layer 52 is 0.2 g/m² or more, and preferably 1.0 g/m² or more in terms of a solid content per unit area. For example, the application amount of the second thermal transfer layer 52 is 7.0 g/m² or less, and preferably 5.0 g/m² or less in terms of the solid content per unit area. For example, the application amount of the second thermal transfer layer 52 is 0.2 g/m² or more and 7.0 g/m² or less, and preferably 1.0 g/m² or more and 5.0 g/m² or less in terms of the solid content per unit area.

A specific thickness of the second thermal transfer layer 52 (before printing) is, for example, 0.05 μm or more, and preferably 1.0 μm or more. The thickness of the second thermal transfer layer 52 is, for example, 7.0 μm or less, and preferably 5.0 μm or less. The thickness of the second thermal transfer layer 52 is, for example, 0.05 μm or more and 7.0 μm or less, and preferably 1.0 μm or more and 5.0 μm or less. The thickness of the second thermal transfer layer 52 can be checked based on, for example, the scanning electron microscope (SEM) image, the transmission electron microscope (TEM) image, or the like of the thermal transfer recording medium 47.

### [Introduction of Middle Layer 51 Based on Irreversible Change in Force]

In FIG. 6, the thermal transfer recording medium 47 including the middle layer 51 containing the thermoplastic elastomer is illustrated as an example of the thermal transfer recording medium (ink ribbon) which enables characters having at least two colors to be simultaneously recorded with good sharpness. The inventors of the present application have studied and realized a thermal transfer recording medium exhibiting a similar effect from another viewpoint, and thus will be described below in detail. In short, while FIG. 6 focuses on a chemical composition of the components of the middle layer 51, the following description focuses on an irreversible change in interlayer adhesive force by reaching temperature control of the thermal transfer recording medium 47.

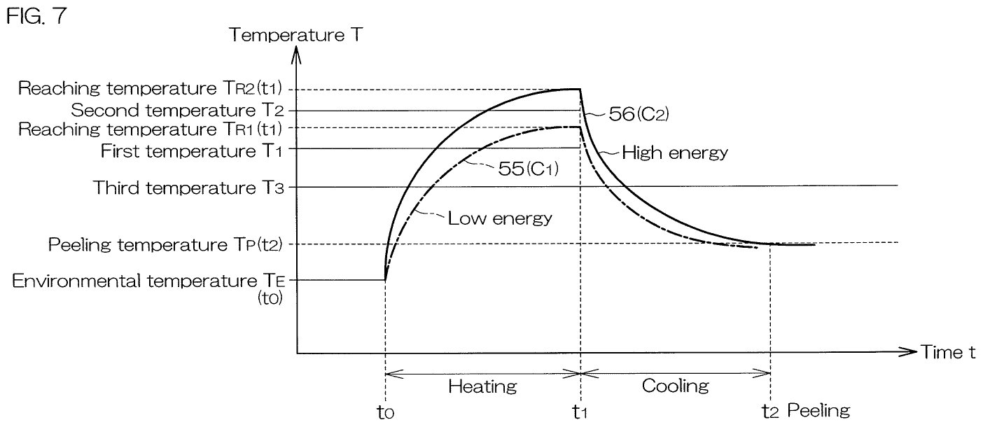

FIG. 7 is a graph illustrating a relationship between an elapsed time and the reaching temperature of the thermal transfer recording medium 47 in the heating step and the cooling step illustrated in FIGS. 1 to 4A and 4B.

The horizontal axis in FIG. 7 represents the elapsed time of the printing step of the printing device 1. Here, t₀ represents a time point of a start of printing, t₁ represents a time point of an end of heating by the thermal head 6, and t₂ represents a time point of arrival at the ink ribbon peeling member 13. The vertical axis in FIG. 7 represents the reaching temperature of the thermal transfer recording medium 47. The reaching temperature of the thermal transfer recording medium 47 can be defined as a temperature of the thermal transfer recording medium 47 that changes due to an external factor. The external factor may include, for example, heating by the thermal head 6, natural cooling during transport of the thermal transfer recording medium 47, and the like.

With reference to FIG. 7, in the printing device 1, the control circuit 22 controls a temperature output (temperature energy) of the thermal head 6, and thereby the reaching temperature of the thermal transfer recording medium 47 can be controlled. For example, a relatively low first energy amount is applied to the thermal head 6 in the heating step. The temperature of the thermal transfer recording medium 47 in this case exponentially increases from an environmental temperature (for example, room temperature) TE around the thermal transfer recording medium 47 and reaches T_{R1}, as illustrated by a first temperature curve 55 represented by a dash-dotted line.

The reaching temperature T_{R1} may be defined as a temperature equal to or higher than the first temperature T1 and equal to or lower than the second temperature T₂. For example, the first temperature T₁ is 60° C. or higher and 120° C. or lower, and preferably 70° C. or higher and 90° C. or lower. For example, the second temperature T2 is 80° C. or higher and 180° C. or lower, and preferably 130° C. or higher and 150° C. or lower. The reaching temperature T_{R1} can be appropriately set according to an output setting method of the thermal head 6 of the printing device 1 to be used. For example, the reaching temperature may be set in association with quantitative parameters such as an energization time, or a voltage or a current which is to be supplied to the heating element 20 of the thermal head 6. In addition, the reaching temperature may be set in association with a relative numerical value with respect to a predetermined reference value (for example, 0 (zero) or the like as a numerical value before energization).

On the other hand, in the heating step, a second energy amount relatively higher than the first energy amount is applied to the thermal head 6. The temperature of the thermal transfer recording medium 47 in this case exponentially increases from the environmental temperature T_{E} and reaches T_{R2} as illustrated by a second temperature curve 56 represented by a solid line. The reaching temperature T_{R2} may be defined as a temperature exceeding the second temperature T2.

After the heating step, the thermal transfer recording medium 47 is naturally cooled in a zone provided until the reach of the ink ribbon peeling member 13 (see also FIGS. 3 and 4A and 4B). In the cooling step, the temperature of the thermal transfer recording medium 47 exponentially decreases from the reaching temperatures T_{R1} and T_{R2} to reach T_{P}. The reaching temperature Tₚ at this time is a temperature at which a part of the thermal transfer recording medium 47 is peeled by the ink ribbon peeling member 13, and thus may be defined as the peeling temperature T_{P}. The peeling temperature T_{P} is preferably equal to or lower than a third temperature T₃. The third temperature T₃ is lower than the first temperature T1 (that is, the first temperature T1 is equal to or higher than the third temperature T₃), and is, for example, 40° C. or higher and 90° C. or lower, and preferably 60° C. or higher and 80° C. or lower. Magnitudes of the first temperature T₁, the second temperature T₂, and the third temperature T₃ can be appropriately set within a temperature range suitable for performing transfer to the printer tape 2 in consideration of the chemical composition and physical properties of ink of the thermal transfer recording medium 47.

A temperature curve (cooling curve) of the thermal transfer recording medium 47 in the cooling step finally converges to a constant temperature through any heating control represented by the first temperature curve 55 and the second temperature curve 56 in the heating step. Hence, the peeling temperatures T_{P} of the first temperature curve 55 and the second temperature curve 56 can be made substantially the same, by securing a long time (t₁→t₂) for the cooling step. In order to lengthen the time of the cooling step, for example, a distance (peeling distance L₁ in FIG. 1) between the thermal head 6 and the ink ribbon peeling member 13 may be lengthened. For example, a state of the thermal transfer recording medium 47 after the heating step and the cooling step are executed due to a temperature change represented by the first temperature curve 55 in FIG. 7 may be defined as a first state C₁. In this respect, a state of the thermal transfer recording medium 47 after the heating step and the cooling step are executed due to a temperature change represented by the second temperature curve 56 in FIG. 7 may be defined as a second state C₂.

As described above, in the printing device 1, in a process from the start of the heating step to the end of the cooling step, control of the temperature output (temperature energy) of the thermal head 6 enables the reaching temperature of the thermal transfer recording medium 47 to variously change while a start temperature (environmental temperature T_{E}) and a final temperature (peeling temperature T_{P}) are maintained constant. In consideration of this temperature control, for example, the temperature output of the thermal head 6 is controlled depending on the individual physical properties of the base material layer 48, the back surface layer 49, the first thermal transfer layer 50, the middle layer 51, and the second thermal transfer layer 52 of the thermal transfer recording medium 47 in FIG. 6, and thereby it is expected to control adhesive forces between the individual layers of the thermal transfer recording medium 47.

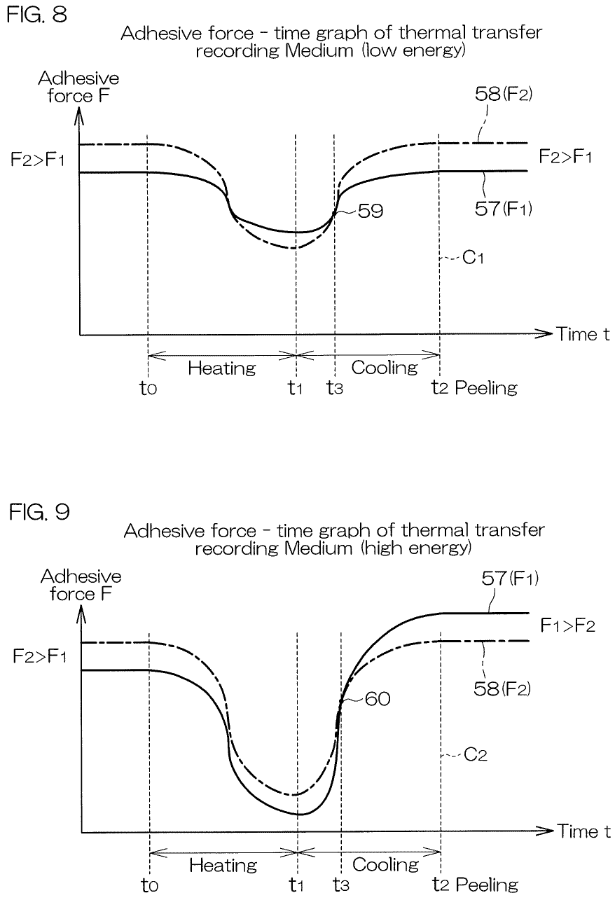

FIGS. 8 and 9 are graphs illustrating relationships between elapsed times and interlayer adhesive forces of the thermal transfer recording medium 47 in the heating step and the cooling step. FIG. 8 illustrates a change in each adhesive force F when the temperature of the thermal transfer recording medium 47 is changed according to the first temperature curve 55 of FIG. 6. FIG. 9 illustrates a change in each adhesive force F when the temperature of the thermal transfer recording medium 47 is changed according to the second temperature curve 56 of FIG. 6.

The horizontal axis in FIGS. 8 and 9 represents the elapsed time of the printing step of the printing device 1. Here, t₀ represents a time point of a start of printing, t₁ represents a time point of an end of heating by the thermal head 6, and t₂ represents a time point of arrival at the ink ribbon peeling member 13. The vertical axis in FIGS. 8 and 9 represents a magnitude of an adhesive force between the layers of the thermal transfer recording medium 47.

In FIGS. 8 and 9, a first adhesive force F₁ between the base material layer 48 and the first thermal transfer layer 50 of the thermal transfer recording medium 47 is represented by a first adhesive force curve 57 illustrated by a solid line. In addition, a second adhesive force F₂ between the first thermal transfer layer 50 and the second thermal transfer layer 52 is represented by a second adhesive force curve 58 illustrated by a dash-dotted line. The first adhesive force F₁ may include a force when the bonding between the base material layer 48 and the first thermal transfer layer 50 is broken, and a force with which the first thermal transfer layer 50 is ruptured inside. The second adhesive force F₂ may include a force when the bonding between the middle layer 51 and the second thermal transfer layer 52 is broken, and a force when the middle layer 51 is ruptured inside. In addition, in a case where the components of the first thermal transfer layer 50 and the middle layer 51 are melted, thereby being mixed to each other to form a mixed layer, each of the forces may include a force when the bonding between the mixed layer and the second thermal transfer layer 52 is broken.

With reference to FIGS. 8 and 9, both the first adhesive force F₁ and the second adhesive force F₂ change with time by executing the heating step and the cooling step regardless of the energy amount applied to the thermal head 6 during the heating step. More specifically, the first adhesive force F₁ and the second adhesive force F₂ both decrease as a heating time elapses, and the first adhesive force F₁ and the second adhesive force F₂ both increase as the cooling time elapses after heating.

A magnitude relationship between the first adhesive force F₁ and the second adhesive force F₂ before the heating and after the cooling changes according to the energy amount applied to the thermal head 6. For example, as illustrated in FIG. 8, in a case where the energy amount applied to the thermal head 6 is relatively low, the second adhesive force F₂ is larger than the first adhesive force F₁ both before the heating and after the cooling (first state C₁). Hence, when peeling is performed in the first state C₁, a condition of the first adhesive force F₁<the second adhesive force F₂ is established, and thus peeling occurs between the base material layer 48 and the first thermal transfer layer 50. Consequently, the first thermal transfer layer 50 and the second thermal transfer layer 52 in an adhering state are transferred to the printer tape 2. On the other hand, in order to adjust the condition of the first adhesive force F₁<the second adhesive force F₂ after the cooling, it is preferable to execute the cooling step at least longer than a time t₃ corresponding to an intersection point 59 between the first adhesive force curve 57 and the second adhesive force curve 58 illustrated in FIG. 9. This is because the thermal transfer recording medium 47 is sufficiently cooled such that cold peeling can be reliably executed.

In addition, for example, as illustrated in FIG. 9, in a case where the energy amount applied to the thermal head 6 is relatively high, the magnitude relationship between the first adhesive force F₁ and the second adhesive force F₂ is reversed before the heating and after the cooling (second state C₂). While the second adhesive force F₂ is larger than the first adhesive force F₁ before the heating, the second adhesive force F₂ is smaller than the first adhesive force F₁ after the cooling (second state C₂). That is, the first adhesive force F₁ causes an irreversible change. Hence, when the peeling is performed in the second state C₂, a condition of the first adhesive force F₁>the second adhesive force F₂ is established, and thus peeling occurs between the first thermal transfer layer 50 and the second thermal transfer layer 52. Consequently, the second thermal transfer layer 52 is transferred to the printer tape 2. On the other hand, in order to adjust the condition of the first adhesive force F₁>the second adhesive force F₂ after the cooling, it is preferable to execute the cooling step at least longer than the time t₃ corresponding to an intersection point 60 between the first adhesive force curve 57 and the second adhesive force curve 58 illustrated in FIG. 9. This is because the thermal transfer recording medium 47 is sufficiently cooled such that cold peeling can be reliably executed.

The time t₃ may be appropriately set so that the condition of the first adhesive force F₁<the second adhesive force F₂ is established after the cooling of the thermal transfer recording medium 47 heated with low energy, and the condition of the first adhesive force F₁>the second adhesive force F₂ is established after the cooling of the thermal transfer recording medium 47 heated with high energy. For example, in both cases of low energy application and high energy application, the time t₃ may be a time taken to lower the reaching temperature of the thermal transfer recording medium 47 below the third temperature T₃. The peeling distance L₁ (see FIG. 1) necessary for securing the time t₃ is, for example, 70 mm or longer and 150 mm or shorter, and preferably 90 mm or longer and 120 mm or shorter.

As described above, if the irreversible change of the first adhesive force F₁ generated according to the energy amount applied to the thermal head 6 is used, a peeling position of the thermal transfer recording medium 47 can be freely controlled, and it is possible to provide the thermal transfer recording medium 47 which enables the characters having at least two colors to be simultaneously recorded with good sharpness.

### (1) Peeling Mode of Thermal Transfer Recording Medium 47

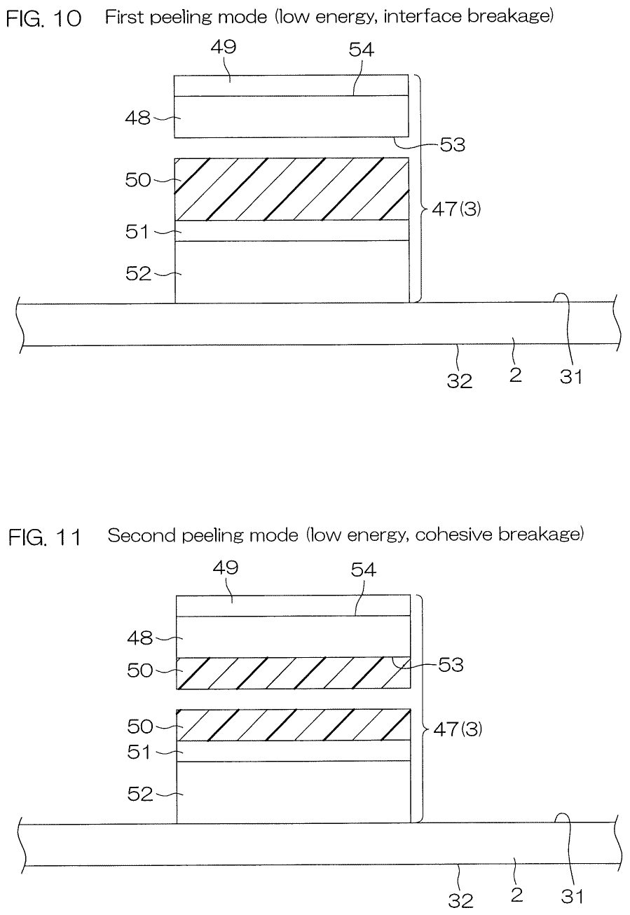

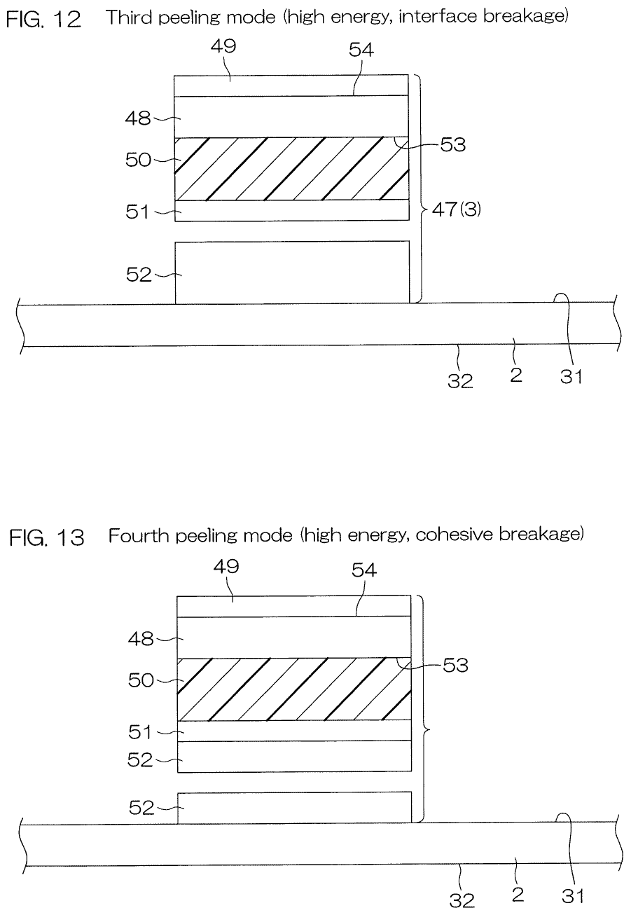

FIGS. 10 to 15 are views illustrating respective peeling states of the thermal transfer recording medium 47. First, how the thermal transfer recording medium 47 is peeled according to the magnitude relationship between the first adhesive force F₁ and the second adhesive force F₂ will be described with reference to FIGS. 10 to 15. With reference to FIGS. 10 to 15, the thermal transfer recording medium 47 includes a plurality of peeling modes. The peeling modes of FIGS. 10 to 15 may be sequentially referred to as first to sixth peeling modes. From the viewpoint of the energy supplied to the thermal head 6, it is possible to distinguish between low energy peeling modes illustrated in FIGS. 10 and 11 and high energy peeling modes illustrated in FIGS. 12 to 15.

FIGS. 10 and 11 illustrate the peeling modes when the peeling (thermal transfer) is performed in the first state C₁ through the heating control (low energy application) of the first temperature curve 55 in FIG. 7. In the first peeling mode in FIG. 10, the thermal transfer recording medium 47 has the lowest rupture strength (the first adhesive force F₁) between the base material layer 48 and the first thermal transfer layer 50 in the first state C₁, and peeling occurs at an interface between these layers. In the second peeling mode in FIG. 11, the thermal transfer recording medium 47 has the lowest rupture strength (the first adhesive force F₁) in the first thermal transfer layer 50 in the first state C₁, and peeling occurs inside the first thermal transfer layer 50. The first peeling mode in FIG. 10 indicates interface breakage, and the second peeling mode in FIG. 11 indicates cohesive breakage. In both the peeling modes in FIGS. 10 and 11, the first thermal transfer layer 50 and the second thermal transfer layer 52 in an adhering state are transferred to the printer tape 2.

FIGS. 12 to 15 illustrate the peeling modes when the peeling (thermal transfer) is performed in the second state C₂ through the heating control (high energy application) of the second temperature curve 56 in FIG. 7. Similarly to the first and second peeling modes, the peeling modes in FIGS. 12 to 15 can also be distinguished into at least two breakage modes of the interface breakage and the cohesive breakage.

In the third peeling mode in FIG. 12, the thermal transfer recording medium 47 has the lowest rupture strength (the second adhesive force F₂) between the first thermal transfer layer 50 and the second thermal transfer layer 52 in the second state C₂, and peeling occurs at an interface between these layers (interface breakage). In the fourth peeling mode in FIG. 13, the thermal transfer recording medium 47 has the lowest rupture strength (the second adhesive force F₂) in the second thermal transfer layer 52 in the second state C₂, and peeling occurs inside the second thermal transfer layer 52 (cohesive breakage).

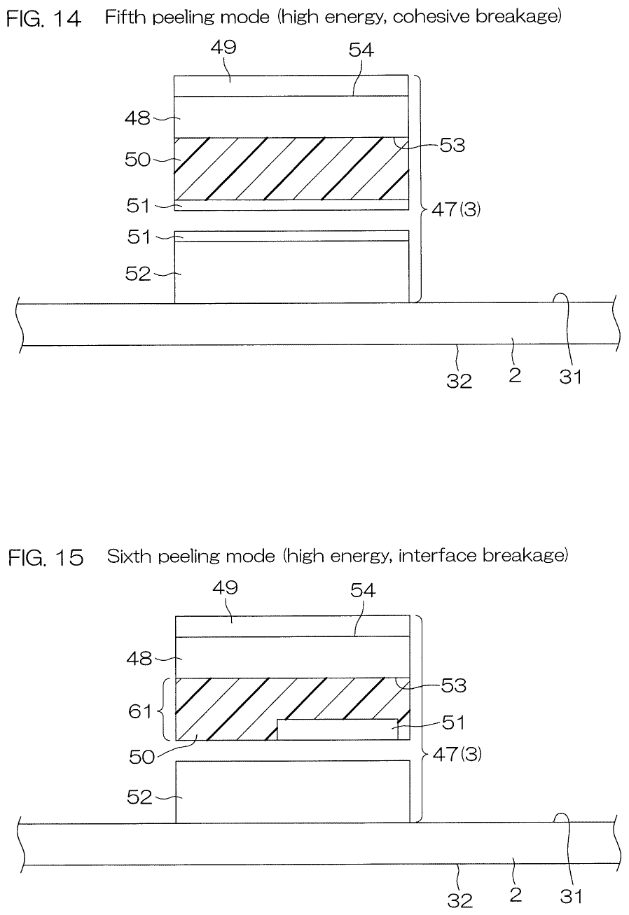

In the fifth peeling mode in FIG. 14, the thermal transfer recording medium 47 has the lowest rupture strength (the second adhesive force F₂) in the middle layer 51 in the second state C₂, and peeling occurs inside the middle layer 51 (cohesive breakage). In the sixth peeling mode in FIG. 15, in the second state C₂, a layer in contact with the second thermal transfer layer 52 is a mixed layer 61 in which the components of the first thermal transfer layer 50 and the middle layer 51 are melted and mixed. Accordingly, the thermal transfer recording medium 47 has the lowest rupture strength (the second adhesive force F₂) between the mixed layer 61 and the second thermal transfer layer 52, and peeling occurs at an interface between these layers (interface breakage).

In all of the peeling modes in FIGS. 12 to 15, the second thermal transfer layer 52 is selectively transferred to the printer tape 2 so that the first thermal transfer layer 50 does not remain.

Whether the thermal transfer recording medium 47 is ruptured in any of the peeling modes in FIGS. 10 to 15 can be checked by, for example, observing a cross section of the thermal transfer recording medium 47 after the rupture. For example, this can be checked based on, for example, a scanning electron microscope (SEM) image, a transmission electron microscope (TEM) image, or the like of the thermal transfer recording medium 47 after the rupture.

As described above, in the first and second peeling modes, the characters to be recorded on the printing surface 31 of the printer tape 2 have the color tone of the first thermal transfer layer 50, for example, black. In the third to sixth peeling modes, the characters to be recorded on the printing surface 31 of the printer tape 2 have the color tone of the second thermal transfer layer 52, for example, red.

Hence, in order to provide the thermal transfer recording medium 47 which enables the characters having at least two colors to be simultaneously recorded with good sharpness, at least one of the first and second peeling modes is completed during the heating control (low energy application) of the first temperature curve 55, and at least one of the third to sixth peeling modes is completed during the heating control (high energy application) of the second temperature curve 56. In order to complete these modes, conditions of the individual layers of the thermal transfer recording medium 47 were examined from a plurality of following viewpoints.

### (2) Chemical Compositions of Individual Layers of Thermal Transfer Recording Medium 47

From the viewpoint of chemical compositions of the individual layers of the thermal transfer recording medium 47, preferable chemical compositions of the individual layers of the base material layer 48, the back surface layer 49, the first thermal transfer layer 50, the middle layer 51, and the second thermal transfer layer 52 are described in the section of “[Introduction of Middle Layer 51 Including Thermoplastic Elastomer]” described above. As a matter of course, since the thermal transfer recording medium 47 having the chemical composition includes the middle layer 51 including the thermoplastic elastomer, the characters having at least two colors can be simultaneously recorded with good sharpness by temperature control under a general condition in a general-purpose thermal transfer printer regardless of the temperature control illustrated in FIG. 7.

In a case where the thermal transfer in the printing device 1 is performed under the temperature control illustrated in FIG. 7, other compositions can be employed as the middle layer 51 in addition to the thermoplastic elastomer described above. For example, the middle layer 51 may include at least one of a polyolefin-based resin and a long-chain alkyl-based resin. These resins have a relatively low polarity. Therefore, when the peeling (thermal transfer) is executed in the second state C₂ through the heating control (high energy application) of the second temperature curve 56 in FIG. 7, the cohesive breakage can occur inside the middle layer 51. Consequently, the first thermal transfer layer 50 and the second thermal transfer layer 52 can be favorably peeled from each other.

Examples of the polyolefin-based resin include SURFLEN (registered trademark) P-1000 manufactured by Mitsubishi Chemical Group.

Examples of the long chain alkyl-based resin include 1010, 1010S, 1050, 1070, 406, and the like in the PEELOIL (registered trademark) series manufactured by LION SPECIALTY CHEMICALS CO., LTD.

By providing the middle layer 51 including the resin exemplified above, it is also possible to provide the thermal transfer recording medium 47 which enables the characters having at least two colors to be simultaneously recorded with good sharpness.

### (3) Solubility Parameter (SP Value) of Individual Layers of Thermal Transfer Recording Medium 47

In terms of physical properties of the individual layers of the thermal transfer recording medium 47, attention is paid to a relative relationship between solubility parameters (SP values) of constituent components of the individual layers. The interlayer adhesive force and the internal peeling of the thermal transfer recording medium 47 can be controlled by adjusting the SP values of the constituent components of the individual layers. The closer the SP values of the constituent components in contact with each other, the easier the adhesion (high affinity), and the more the SP values are different, the easier the peeling (lower affinity). Hence, a peeling position in the thermal transfer recording medium 47 is flexibly controlled by adjusting the balance between the SP values and the percentage content of the constituent components of the individual layers of the thermal transfer recording medium 47. Consequently, the thermal transfer recording medium 47 which enables the characters having at least two colors to be simultaneously recorded with good sharpness is provided.

In the following description, in a case where the relative relationship (magnitude relationship) between the SP values is described, calculation conditions of comparison target SP values may be the same. For example, the SP value may be an HSP value (Hansen solubility parameter) or an SP value (Hildebrand solubility parameter). In addition, the method of calculating the SP value is not particularly limited, and may be, for example, any one of a method of obtaining the SP value from evaporative latent heat, a method of estimating the SP value from physical property values such as a method in accordance with Hildebrand Rule or a method by surface tension, and a method of estimating the SP value from molecular structures such as the calculation method of Small, the calculation method of Fedors, the calculation method of Hansen, and the calculation method of Hoy. Note that, in the present disclosure, the SP values in the case of indicating a range of the SP values and specific numerical values are SP values (Hildebrand solubility parameters) unless otherwise specified.

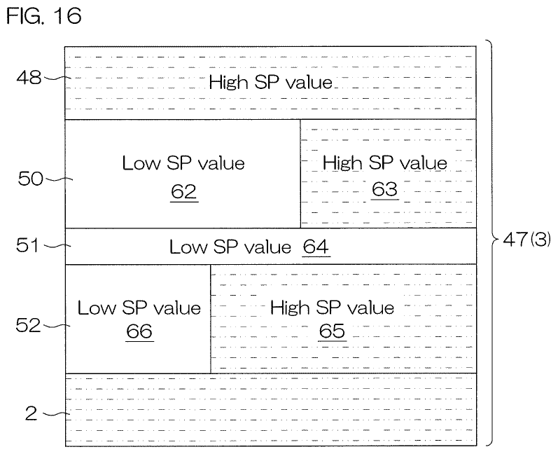

FIG. 16 is a diagram for comparing solubility parameters (SP values) of individual constituent materials of the thermal transfer recording medium 47 according to a preferred embodiment of the present disclosure.

With reference to FIG. 16, the first thermal transfer layer 50 includes at least a first material 62 and a second material 63. The first material 62 is a material having an SP value relatively lower than that of the second material 63. The SP value of the first material 62 is, for example, 7.5 to 9.5, and preferably 8.0 to 9.0. Examples of the first material 62 include the adhesive and the tackifier exemplified as the components of the first thermal transfer layer 50 in “[Introduction of Middle Layer 51 Including Thermoplastic Elastomer]” described above.

The second material 63 is a material having an SP value relatively higher than that of the first material 62. The SP value of the second material 63 is, for example, 9.0 to 12.0, and preferably 10.0 to 11.0. Examples of the second material 63 include the thermoplastic resins exemplified as the components of the first thermal transfer layer 50 in “[Introduction of Middle Layer 51 Including Thermoplastic Elastomer]” described above.

Regarding weight ratios of the first material 62 and the second material 63 in the first thermal transfer layer 50, for example, the weight ratio of the first material 62 is 30 parts by mass or more, and preferably 45 parts by mass or more with respect to 100 parts by mass of the second material 63. For example, the ratio of the first material 62 is 300 parts by mass or less, and preferably 200 parts by mass or less with respect to 100 parts by mass of the second material 63. For example, the ratio of the first material 62 is 30 parts by mass or more and 300 parts by mass or less, and preferably 45 parts by mass or more and 200 parts by mass or less with respect to 100 parts by mass of the second material 63.

The middle layer 51 includes at least a third material 64. The third material 64 is a material having an SP value relatively lower than those of the second material 63 and a fifth material 66 (to be described below). The SP value of the third material 64 is, for example, 7.5 to 10.0, and preferably 8.0 to 9.0. Examples of the third material 64 include a polyolefin-based resin and a long-chain alkyl-based resin in addition to the thermoplastic elastomers exemplified in “[Introduction of Middle Layer 51 Including Thermoplastic Elastomer]” described above.

The second thermal transfer layer 52 includes at least a fourth material 65 and the fifth material 66. The fourth material 65 is a material having an SP value relatively higher than that of the fifth material 66. The SP value of the fourth material 65 is, for example, 9.0 to 12.0, and preferably 10.0 to 11.0. Examples of the fourth material 65 include the thermoplastic resins or the like exemplified as the components of the second thermal transfer layer 52 in “[Introduction of Middle Layer 51 Including Thermoplastic Elastomer]” described above.

The fifth material 66 is a material having an SP value relatively lower than that of the fourth material 65. The SP value of the fifth material 66 is, for example, 7.5 to 9.5, and preferably 8.0 to 9.0. Examples of the fifth material 66 include the wax or the like exemplified as the components of the second thermal transfer layer 52 in “[Introduction of Middle Layer 51 Including Thermoplastic Elastomer]” described above.

Regarding weight ratios of the fourth material 65 and the fifth material 66 in the second thermal transfer layer 52, for example, the weight ratio of the fifth material 66 is 3 parts by mass or more, and preferably 5 parts by mass or more with respect to 100 parts by mass of the fourth material 65. For example, the weight ratio of the fifth material 66 is 11 parts by mass or less, and preferably 9 parts by mass or less with respect to 100 parts by mass of the fourth material 65. For example, the weight ratio of the fifth material 66 is 3 parts by mass or more and 11 parts by mass or less, and preferably 5 parts by mass or more and 9 parts by mass or less with respect to 100 parts by mass of the fourth material 65.

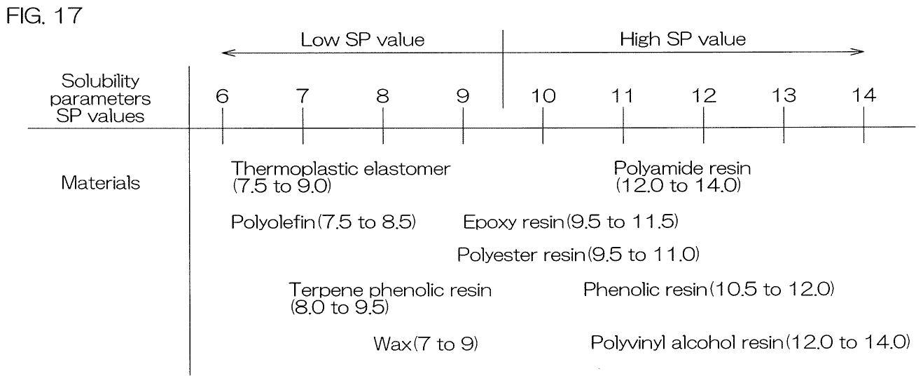

FIG. 17 is a diagram illustrating a relationship between a kind of a material constituting a part of the thermal transfer recording medium 47 and a magnitude of a solubility parameter.

As described above, material names that can be used as the first to fifth materials 62 to 66 have been exemplified, but the materials to be used are not particularly limited as long as a relative relationship (magnitude relationship) between the SP values in the thermal transfer recording medium 47 is as described above. For example, a material can be appropriately selected with reference to the magnitude relationship illustrated in FIG. 17. At this time, it is considered that the closer the SP values between the materials, the easier the adhesion, and the more the SP values are different, the easier the peeling.

For example, regarding the first thermal transfer layer 50, a terpene phenolic resin may be selected as the first material 62, and an epoxy resin may be selected as the second material 63. For example, regarding the middle layer 51, a thermoplastic elastomer, a polyolefin, or the like may be selected as the third material 64. For example, regarding the second thermal transfer layer 52, wax may be selected as the fourth material 65, and an epoxy resin may be selected as the fifth material 66.

When the SP values are combined as described above, at least one of the first and second peeling modes can be completed during the heating control (low energy application) of the first temperature curve 55 in FIG. 7, and at least one of the third to sixth peeling modes can be completed during the heating control (high energy application) of the second temperature curve 56. As a result, it is possible to provide the thermal transfer recording medium 47 which enables the characters having at least two colors to be simultaneously recorded with good sharpness.

### EXAMPLES

Hereinafter, the present disclosure will be further described based on a plurality of samples, but the configuration of the present disclosure is not limited to these examples.

### [Coating Material (I) for First Thermal Transfer Layer]

Individual components illustrated in Table 1 below were dissolved in a mixed solvent of toluene and methyl ethyl ketone (MEK) at a mass ratio of ¼ to prepare a coating material (I) for the first thermal transfer layer having a solid content concentration of 22.5 mass %. A ratio of the active component in the acrylic adhesive was 80 parts by mass with respect to 100 parts by mass of the epoxy resin.

TABLE 1

| Components | Parts by mass |
|---|---|
| Epoxy resin | 100 |
| Acrylic adhesive | 200 |
| Tackifier | 28.3 |
| Carbon black | 166.7 |

The components in the table are as follows.

Epoxy resin: JER1007 [basic solid type, softening point (ring-and-ball method): 128° C., number average molecular weight Mn: about 2,900, SP value: 9.5 to 11.5] manufactured by Mitsubishi Chemical Group Acrylic adhesive: AS-665 [solid content concentration: 40 mass %, SP value: 8.0 to 9.0] manufactured by LION SPECIALTY CHEMICALS CO., LTD.

Tackifier: Terpene phenolic resin, YS POLYSTER T80 (softening point: 80±5° C., SP value: 8.0 to 9.5) manufactured by YASUHARA CHEMICAL Co., Ltd.

Carbon black: MA100 Powder form [LFF, DBP absorption number: 100 cm³/100 g] manufactured by Mitsubishi Chemical Group

### [Coating Material (II) for First Thermal Transfer Layer]

A coating material (II) for the first thermal transfer layer was prepared in the same manner as the coating material (I) for the first thermal transfer layer, except that the same amount of JER1004 [basic solid type, softening point (ring-and-ball method): 97° C., number average molecular weight Mn: about 1,650, SP value: 9.5 to 11.5] manufactured by Mitsubishi Chemical Group was blended as the epoxy resin. The solid content concentration was 22.5 mass %, and the ratio of the active component in the acrylic adhesive was 80 parts by mass with respect to 100 parts by mass of the epoxy resin.

### [Coating Material (III) for First Thermal Transfer Layer]

A coating material (III) for the first thermal transfer layer was prepared in the same manner as the coating material (I) for the first thermal transfer layer, except that no tackifier was blended and the weight ratio of the acrylic adhesive was 271 parts by mass. The solid content concentration was 22.5 mass %, and the ratio of the active component in the acrylic adhesive was 108.4 parts by mass with respect to 100 parts by mass of the epoxy resin. [0168][Coating Material (1) for Middle Layer]A thermoplastic elastomer [Tuftec H1521, SEBS, MFR: 12.3 g/10 min, 18 mass % of percentage styrene content, SP value: 7.5 to 9.0, manufactured by Asahi Kasei Corporation] was dissolved in a mixed solvent of toluene and hexane at a mass ratio of 1/1 to prepare a coating material (1) for the middle layer having a solid content concentration of 10 mass %.

### [Coating Material (2) for Middle Layer]

A coating material (2) for the middle layer was prepared in the same manner as the coating material (1) for the middle layer, except that the same amount of Tuftec H1517 [SEBS, MFR: less than 3.0 g/10 min, 43 mass % of percentage styrene content, SP value: 7.5 to 9.0] manufactured by Asahi Kasei Corporation was blended as the thermoplastic elastomer. The solid content concentration was 10 mass %.

### [Coating Material (3) for Middle Layer]

A coating material (3) for the middle layer was prepared in the same manner as the coating material (1) for the middle layer, except that the same amount of Tuftec H1272 [SEBS, MFR: No Flow, 35 mass % of percentage styrene content, SP value: 7.5 to 9.0] manufactured by Asahi Kasei Corporation was blended as the thermoplastic elastomer. The solid content concentration was 10 mass %.

### [Coating Material (4) for Middle Layer]

A coating material (4) for the middle layer was prepared in the same manner as the coating material (1) for the middle layer, except that the same amount of Tuftec H1221 [SEBS, MFR: less than 4.5 g/10 min, 12 mass % of percentage styrene content, SP value: 7.5 to 9.0] manufactured by Asahi Kasei Corporation was blended as the thermoplastic elastomer. The solid content concentration was 10 mass %.

### [Coating Material (5) for Middle Layer]

A coating material (5) for the middle layer was prepared in the same manner as the coating material (1) for the middle layer, except that the same amount of Tuftec H1043 [SEBS, MFR: less than 2.0 g/10 min, 67 mass % of percentage styrene content, SP value: 7.5 to 9.0] manufactured by Asahi Kasei Corporation was blended as the thermoplastic elastomer. The solid content concentration was 10 mass %.

### [Coating Material (6) for Middle Layer]

A coating material (6) for the middle layer was prepared in the same manner as the coating material (1) for the middle layer, except that the same amount of Tufprene A [SBS, MFR: 2.6 g/10 min, 40 mass % of percentage styrene content, SP value: 7.5 to 9.0] manufactured by Asahi Kasei Corporation was blended as the thermoplastic elastomer. The solid content concentration was 10 mass %.

### [Coating Material (7) for Middle Layer]

A coating material (7) for the middle layer was prepared in the same manner as the coating material (1) for the middle layer, except that the same amount of Ultrathene 634 [EVA, MFR: 4.3 g/10 min, SP value: 7.5 to 9.0]manufactured by Tosoh Corporation was blended as the thermoplastic elastomer. The solid content concentration was 10 mass %.

### [Coating Material (8) for Middle Layer]

A coating material (8) for the middle layer was prepared in the same manner as the coating material (1) for the middle layer, except that the same amount of Ultrathene 722 [EVA, MFR: 400 g/10 min, SP value: 7.5 to 9.0] manufactured by Tosoh Corporation was blended as the thermoplastic elastomer. The solid content concentration was 10 mass %.

### [Coating Material (9) for Middle Layer]

A coating material (9) for the middle layer was prepared in the same manner as the coating material (1) for the middle layer, except that the same amount of Ultrathene 725 [EVA, MFR:1,000 g/10 min, SP value: 7.5 to 9.0] manufactured by Tosoh Corporation was blended as the thermoplastic elastomer. The solid content concentration was 10 mass %.

### [Coating Material (10) for Middle Layer]

A coating material (10) for the middle layer was prepared in the same manner as the coating material (1) for the middle layer, except that the same amount of Ultrathene 684 [EVA, MFR: 2,000 g/10 min, SP value: 7.5 to 9.0] manufactured by Tosoh Corporation was blended as the thermoplastic elastomer. The solid content concentration was 10 mass %.

### [Coating Material (11) for Middle Layer]

A coating material (11) for the middle layer was prepared in the same manner as the coating material (1) for the middle layer, except that the same amount of an amorphous polyester resin [VYLON (registered trademark) 200 manufactured by Toyobo Co., Ltd., SP value: 9.5 to 11.0] which is a thermoplastic resin was blended instead of the thermoplastic elastomer. The solid content concentration was 10 mass %.

### [Coating Material (12) for Middle Layer]

A coating material (12) for the middle layer was prepared in the same manner as the coating material (1) for the middle layer, except that the same amount of wax [carnauba wax No. 2 Flake (melting point: 80 to 86° C.) manufactured by TOYOCHEM CO., LTD., SP value: 7.0 to 9.0] was blended instead of the thermoplastic elastomer. The solid content concentration was 10 mass %.

### [Coating Material (13) for Middle Layer]

A coating material (13) for the middle layer was prepared in the same manner as the coating material (1) for the middle layer, except that the same amount of a modified polyolefin resin [SURFLEN (registered trademark) P-1000 manufactured by Mitsubishi Chemical Group, SP value: 7.5 to 8.5] was blended instead of the thermoplastic elastomer. The solid content concentration was 10 mass %.

Material names, MFR, and styrene contents of the coating materials (1) to (13) for the middle layer are listed as shown in Table 2 below. The blending ratio of the constituent components is omitted since any one of the coating materials (1) to (13) for the middle layer has a blending ratio of solid content/toluene/hexane=10/45/45.

TABLE 2

| | | | | Percentage |
|---|---|---|---|---|
| | | | | styrene |
| | | | MFR | content |
| | Material names | | (g/10 min) | (mass %) |
| Middle 1 | TuftecH1521 | SEBS | 2.3 | 18 |
| Middle 2 | TuftecH1517 | ↑ | <3.0 | 43 |
| Middle 3 | TuftecH1272 | ↑ | No Flow | 35 |
| Middle 4 | TuftecH1221 | ↑ | <4.5 | 12 |
| Middle 5 | TuftecH1043 | ↑ | <2.0 | 67 |
| Middle 6 | Tufprene A | SBS | 2.6 | 40 |
| Middle 7 | Ultrathene 634 | EVA | 4.3 | — |
| Middle 8 | Ultrathene 722 | ↑ | 400 | — |
| Middle 9 | Ultrathene 725 | ↑ | 1000 | — |
| Middle 10 | Ultrathene 684 | ↑ | 2000 | — |
| Middle 11 | VYLON 200 | Polyester | — | — |
| | | resin | | |
| Middle 12 | Wax | Wax | — | — |
| Middle 13 | SURFLEN P-1000 | Modified | — | — |
| | | polyolefin | | |

### [Coating Material (I) for Second Thermal Transfer Layer]

Individual components illustrated in Table 3 below were dissolved in a mixed solvent of toluene and MEK at a mass ratio of ¼ to prepare a coating material (I) for the second thermal transfer layer having a solid content concentration of 28 mass %.

TABLE 3

| Components | Parts by mass |
|---|---|
| Epoxy resin | 100 |
| Wax | 7.1 |
| Red pigment | 92.9 |

The components in the table are as follows.

Epoxy resin: JER1004 [basic solid type, softening point (ring-and-ball method): 97° C., number 11.5] average molecular weight Mn: about 1,650, SP value: 9.5 to manufactured by Mitsubishi Chemical Group

Wax: Carnauba wax No. 2 Powder (Melting point: 80 to 86° C., SP value: 7.0 to 9.0) manufactured by TOYOCHEM CO., LTD.

Red pigment: C.I. Pigment Red 53:1 [SYMULER (registered trademark) Lake Red C-102 manufactured by DIC CORPORATION]

### [Samples 1 to 15]

### (1) Manufacture of Thermal Transfer Recording Medium

First, a PET film having a thickness of 4.5 μm was prepared as a base material layer. Next, a back surface layer made of a silicone-based resin and having a solid content of 0.1 g/m² per unit area was formed on a surface (back surface) of the base material layer opposite to a front surface on which a thermal transfer layer was to be formed. Next, any one coating material for a first thermal transfer layer which was previously prepared was applied to the front surface of the base material layer and then dried to form a first thermal transfer layer having a solid content of 1.5 g/m² per unit area. Next, any one coating material for a middle layer which was previously prepared was applied on the first thermal transfer layer and then dried to form a middle layer having a solid content of 1 g/m² per unit area. Next, a coating material (I) for a second thermal transfer layer which was previously prepared was applied on the middle layer and then dried to form a second thermal transfer layer having a solid content of 2.5 g/m² per unit area, and thereby a thermal transfer recording medium was manufactured. The compositions of the individual layers of the thermal transfer recording medium obtained in samples 1 to 15 are as shown in Tables 4 to 6 below. In the tables, NF in the binder column of the middle layer represents No Flow.

### (2) Evaluation

### (2-1) Evaluation of Continuous Recordability

A thermal transfer recording medium manufactured in each sample was slit into a ribbon shape having a predetermined width, wound in a roll shape, and set in a thermal transfer printer [Zebra 110Xi4 printer manufactured by Zebra Technologies Corp.]. Next, an energy value which was set in advance in the thermal transfer printer and applied to a thermal head was set to 16 (low temperature, black) or 24 (high temperature, red) in an environment with an outside temperature of 25° C., and a solid image having a size of 70 mm² was continuously recorded 20 times on a front surface of a label material for printing variable information [polyester film (white, glossy), FR1415-50 manufactured by LINTEC Corporation] in a condition of a printing speed of 5 inch/sec. In a case where slight duskiness was observed during recording, the continuous printing was ended at that time point, and the number of times of printing in black or red was recorded as the number of continuous printing. In an evaluation, a sample in which black is printed even at the twentieth time has twenty times or more of excellent continuous printability, and a sample in which duskiness occurs at the third time or earlier is considered not to be suitable for use. The results are shown in Tables 4 to 6.

### (2-2) Evaluation of Sharpness of Recording

A thermal transfer recording medium manufactured in each sample was slit into a ribbon shape having a predetermined width, wound in a roll shape, and set in a thermal transfer printer [Zebra 110Xi4 printer manufactured by Zebra Technologies Corp.]. Next, an energy value which was set in advance in the thermal transfer printer and applied to a thermal head was set to 16 (low temperature, black) or 24 (high temperature, red) in an environment with an outside temperature of 25° C., and a barcode was recorded on a front surface of a label material for printing variable information [polyester film (white, glossy), FR1415-50 manufactured by LINTEC Corporation] in a condition of a printing speed of 5 inch/sec. Accordingly, a decodability grade prescribed in American National Standards Institute Standard ANSI X3.182-1990 was determined from a result of reading the recorded barcode using a bar-code verifier [Laser Xaminer Elite IS manufactured by Munazo INC.], and sharpness of the recording was evaluated according to the following criteria.
◯: Both black and red had a decodability grade of A [very excellent] or B [excellent].
Δ: One of black or red had a decodability grade of C [good] and the other had a decodability grade of C [good] or higher.
X: At least one of black or red had a decodability grade of D [acceptable] or F [unacceptable].

The results are shown in Tables 4 to 6. Note that, of the samples 1 to 15, the samples 1 to 12 are Examples, and the samples 13 to 15 may be Comparative Examples.

TABLE 4

| | | | Sample 1 | Sample 13 | Sample 2 | Sample 3 | Sample 4 |
|---|---|---|---|---|---|---|---|
| First thermal | Types | | (I) | (I) | (I) | (I) | (I) |
| transfer layer | Softening point of | | 128 | 128 | 128 | 128 | 128 |
| | epoxy resin (° C.) | | | | | | |
| | Tackifier | | Added | Added | Added | Added | Added |
| Middle layer | Types | | (1) | — | (2) | (3) | (4) |
| | Binder | Types | SEBS | — | SEBS | SEBS | SEBS |
| | | MFR | 2.3 | — | <3.0 | NF | <4.5 |
| | | (g/10 min) | | | | | |

| | | | | | | |
|---|---|---|---|---|---|---|
| Second thermal | Types | (I) | (I) | (I) | (I) | (I) |
| transfer layer | Softening point of | 97 | 97 | 97 | 97 | 97 |
| | epoxy resin (° C.) | | | | | |
| Evaluation | Continuous | >20 | 1 | >20 | >20 | 15 |
| | recordability (times) | | | | | |
| | Sharpness | ∘ | Δ | ∘ | ∘ | ∘ |

TABLE 5

| | | | Sample 5 | Sample 6 | Sample 7 | Sample 8 | Sample 9 |
|---|---|---|---|---|---|---|---|
| First thermal | Types | | (I) | (I) | (I) | (I) | (I) |
| transfer layer | Softening point of | | 128 | 128 | 128 | 128 | 128 |
| | epoxy resin (° C.) | | | | | | |
| | Tackifier | | Added | Added | Added | Added | Added |
| Middle layer | Types | | (5) | (6) | (7) | (8) | (9) |
| | Binder | Types | SEBS | SBS | EVA | EVA | EVA |
| | | MFR | <2.0 | 2.6 | 4.3 | 400 | 1000 |
| | | (g/10 min) | | | | | |

| | | | | | | |
|---|---|---|---|---|---|---|
| Second thermal | Types | (I) | (I) | (I) | (I) | (I) |
| transfer layer | Softening point of | 97 | 97 | 97 | 97 | 97 |
| | epoxy resin (° C.) | | | | | |
| Evaluation | Continuous | 15 | 12 | 10 | 10 | 7 |
| | recordability (times) | | | | | |
| | Sharpness | ∘ | ∘ | ∘ | ∘ | ∘ |

TABLE 6

| | | | Sample 10 | Sample 14 | Sample 15 | Sample 11 | Sample 12 |
|---|---|---|---|---|---|---|---|
| First thermal | Types | | (I) | (I) | (I) | (II) | (III) |
| transfer layer | Softening point of | | 128 | 128 | 128 | 97 | 128 |
| | epoxy resin (° C.) | | | | | | |
| | Tackifier | | Added | Added | Added | Added | Not |
| | | | | | | | added |
| Middle layer | Types | | (10) | (11) | (12) | (1) | (1) |
| | Binder | Types | EVA | Thermoplastic | SEBS | SEBS | SEBS |
| | | MFR | 2000 | resin | 2.3 | 2.3 | 2.3 |
| | | (g/10 min) | | | | | |

| | | | | | | |
|---|---|---|---|---|---|---|
| Second thermal | Types | (I) | (I) | (I) | (I) | (I) |
| transfer layer | Softening point of | 97 | 97 | 97 | 97 | 97 |
| | epoxy resin (° C.) | | | | | |
| Evaluation | Continuous | 5 | 0 | 0 | 13 | 13 |
| | recordability (times) | | | | | |
| | Sharpness | ∘ | ∘ | x | ∘ | Δ |

From comparison between the samples 1 to 12 and the samples 13 to 15 in Tables 4 to 6, it has been found that, by providing a middle layer made of a thermoplastic elastomer between the first thermal transfer layer and the second thermal transfer layer, a thermal transfer recording medium which does not allow color tones to become dusky, enables the color tones to be clearly separated into two colors even in continuous thermal transfer recording, and further enables characters to be recorded with excellent sharpness without causing extra peeling is obtained.

IN addition, from the results of the samples 1 to 12, it has been found that EVA, SBS, SEBS, and the like are preferable as the thermoplastic elastomer for forming the middle layer. Further, in consideration of further improvement in the continuous recordability, it has been found that a thermoplastic elastomer having the MFR of 1000 g/10 min or less, more preferably 400 g/10 min or less, particularly preferably 2.5 g/10 min or less, and most preferably 2.3 g/10 min or less at a temperature of 190° C. and under a load of 2.16 kg is preferable as the thermoplastic elastomer.

From comparison between the sample 1 and the sample 11, it has been found that an epoxy resin having a softening point of preferably 95° C. or higher, more preferably 110° C. or higher, and particularly preferably 125° C. or higher is preferable as the epoxy resin of which the first thermal transfer layer is made. Further, from comparison between the sample 1 and the sample 12, it has been found that it is preferable to blend both of an acrylic adhesive and a tackifier in the epoxy resin of which the first thermal transfer layer is made.

### [Samples 16 to 33]

### (1) Manufacture of Thermal Transfer Recording Medium

First, a PET film having a thickness of 4.5 μm was prepared as a base material layer. Next, a back surface layer made of a silicone-based resin and having a solid content of 0.1 g/m² per unit area was formed on a surface (back surface) of the base material layer opposite to a front surface on which a thermal transfer layer was to be formed. Next, any one coating material for a first thermal transfer layer which was previously prepared was applied to the front surface of the base material layer and then dried to form a first thermal transfer layer having a solid content of 1.7 g/m² per unit area. Next, any one coating material for a middle layer which was previously prepared was applied on the first thermal transfer layer and then dried to form a middle layer. Regarding the application amount of the coating material for a middle layer, the solid content per unit area was 1 g/m² in the samples 16 to 29, and the solid content per unit area was as shown in Table 10 below in the samples 30 to 33. Next, a coating material (I) for a second thermal transfer layer which was previously prepared was applied on the middle layer and then dried to form a second thermal transfer layer having a solid content of 2.5 g/m² per unit area, and thereby a thermal transfer recording medium was manufactured. The compositions of the individual layers of the thermal transfer recording medium obtained in the samples 16 to 33 are as shown in Tables 7 to 10 below. In the tables, NF in the binder column of the middle layer represents No Flow.

### (2) Evaluation

### (2-1) Evaluation of Continuous Recordability

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.]. Main specifications of the thermal transfer printer are as follows.
<Resolution>300 dpi Line Thermal Head
<Resistance Value of Heating Element>1,830 Ω
<Transfer Load>30 N/2 inch
<Transport Speed>20 mm/sec
<Peeling Distance>110 mm

Next, an energy value which was set in advance in the thermal transfer printer and applied to a thermal head was set to low energy (0.25 mJ/dot: 25 V (0.34 W/dot)/750 μsec, black) or high energy (0.34 mJ/dot: 25 V (0.34 W/dot)/1,000 μsec, red), in an environment with an outside temperature of 25° C., and a solid image having a size of 70 mm² was continuously recorded 20 times on a front surface of a label material for printing variable information [polyester film (white, glossy), FR1415-50 manufactured by LINTEC Corporation]. In a case where slight duskiness was observed during recording, the continuous printing was ended at that time point, and the number of times of printing in black or red was recorded as the number of continuous printing. In an evaluation, a sample in which black is printed even at the twentieth time has twenty times or more of excellent continuous printability, and a sample in which duskiness occurs at the third time or earlier is considered not to be suitable for use. The results are shown in Tables 7 to 10.

### (2-2) Evaluation of Sharpness of Recording

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.] having the same specifications as those of (2-1). Next, an energy value which was applied to a thermal head and set in advance in the thermal transfer printer was set to low energy (0.25 mJ/dot: 25 V (0.34 W/dot)/750 Psec, black) or high energy (0.34 mJ/dot: 25 V (0.34 W/dot)/1,000 μsec, red), in an environment with an outside temperature of 25° C., and a barcode was recorded on a front surface of a label material for printing variable information [polyester film (white, glossy), FR1415-50 manufactured by LINTEC Corporation]. Accordingly, a decodability grade prescribed in American National Standards Institute Standard ANSI X3.182-1990 was determined from a result of reading the recorded barcode using a bar-code verifier [Laser Xaminer Elite IS manufactured by Munazo INC.], and sharpness of the recording was evaluated according to the following criteria.
◯: Both black and red had a decodability grade of A [very excellent] or B [excellent].
Δ: One of black or red had a decodability grade of C [good] and the other had a decodability grade of C [good] or higher.
x: At least one of black or red had a decodability grade of D [acceptable] or F [unacceptable].

The results are shown in Tables 7 to 10. Note that, of the samples 16 to 33, the samples 16 to 28 and the samples 30 to 33 are Examples, and the sample 29 may be a comparative example.

### (2-3) Observation of Rupture Position

The thermal transfer recording medium manufactured in each sample was slit into a ribbon shape having a predetermined width, wound in a roll shape, and set in a thermal transfer printer [Prototype Printer manufactured by BROTHER INDUSTRIES, LTD.] having the same specifications as those of (2-1). Next, energy values which were set in advance in the thermal transfer printer and applied to a thermal head were individually set to low energy (0.25 mJ/dot: 25 V (0.34 W/dot)/750 μsec, reaching temperature T_{R1}: 80° C., black) or high energy (0.34 mJ/dot: 25 V (0.34 W/dot)/1,000 μsec, reaching temperature T_{R2}: 140° C., red), in an environment with an outside temperature of 25° C., and a solid image having a size of 70 mm² was recorded on a front surface of a label material for printing variable information [polyester film (white, glossy), FR1415-50 manufactured by LINTEC Corporation]. In any case, since the peeling distance of the thermal transfer printer is secured to 110 mm, the thermal transfer printer is sufficiently cooled (60° C. or lower) and then subjected to the peeling treatment. A cross section of the obtained solid image was observed using a transmission type electron microscope (TEM: HT7820 with acceleration voltage of 100 kV manufactured by Hitachi High-Technologies Corporation). In each of the black transfer and the red transfer, a position of a rupture in the thermal transfer recording medium was checked. The rupture position was identified in the peeling mode as follows.

First peeling mode: between the base material layer and the first thermal transfer layer (interface breakage, see FIG. 10)

Second peeling mode: inside the first thermal transfer layer (cohesive breakage, see FIG. 11)

Third peeling mode: between the middle layer and the second thermal transfer layer (interface breakage, see FIG. 12)

Fourth peeling mode: inside the second thermal transfer layer (cohesive breakage, see FIG. 13)

Fifth peeling mode: inside the middle layer (cohesive breakage, see FIG. 14)

Sixth peeling mode: between the mixed layer and the second thermal transfer layer (interface breakage, see FIG. 15)

The results are shown in Tables 7 to 10. In Tables 7 to 10, each of the first to sixth peeling modes is represented only by a number surrounded by a circle. In addition, in Tables 7 to 10, the case of arranging a plurality of peeling modes indicates that the peeling modes different from each other occur in an in-plane direction of the thermal transfer recording medium. In addition, since the sample 29 has a layer configuration without a middle layer, strictly speaking, the cohesive breakage and the interface breakage occurred in the peeling mode at the lower part of Table 7 in a state in which the middle layer 51 is omitted from FIGS. 13 and 15.

TABLE 7

| | | | Sample 16 | Sample 29 | Sample 17 | Sample 18 | Sample 19 |
|---|---|---|---|---|---|---|---|
| First thermal | Types | | (I) | (I) | (I) | (I) | (I) |
| transfer layer | Softening point of | | 128 | 128 | 128 | 128 | 128 |
| | epoxy resin (° C.) | | | | | | |
| | Tackifier | | Added | Added | Added | Added | Added |
| Middle layer | Types | | (1) | — | (2) | (3) | (4) |
| | Binder | Types | SEBS | — | SEBS | SEBS | SEBS |
| | | MFR | 2.3 | — | <3.0 | NF | <4.5 |
| | | (g/10 min) | | | | | |

| | | | | | | |
|---|---|---|---|---|---|---|
| Second thermal | Types | (I) | (I) | (I) | (I) | (I) |
| transfer layer | Softening point of | 97 | 97 | 97 | 97 | 97 |
| | epoxy resin (° C.) | | | | | |
| Evaluation | Continuous | >20 | 1 | >20 | >20 | 15 |
| | recordability (times) | | | | | |
| | Sharpness | ∘ | Δ | ∘ | ∘ | ∘ |
| | Peeling mode (upper | \textcircled{1} | \textcircled{1} | \textcircled{1} | \textcircled{1} | \textcircled{1} |
| | row: black, lower | \textcircled{3} | \textcircled{4} + \textcircled{6} | \textcircled{3} | \textcircled{3} | \textcircled{3} |
| | row: red) | | | | | |

TABLE 8

| | | | Sample 20 | Sample 21 | Sample 22 | Sample 23 | Sample 24 |
|---|---|---|---|---|---|---|---|
| First thermal | Types | | (I) | (I) | (I) | (I) | (I) |
| transfer layer | Softening point of | | 128 | 128 | 128 | 128 | 128 |
| | epoxy resin (° C.) | | | | | | |
| | Tackifier | | Added | Added | Added | Added | Added |
| Middle layer | Types | | (5) | (6) | (7) | (8) | (9) |
| | Binder | Types | SEBS | SBS | EVA | EVA | EVA |
| | | MFR | <2.0 | 2.6 | 4.3 | 400 | 1000 |
| | | (g/10 min) | | | | | |

| | | | | | | |
|---|---|---|---|---|---|---|
| Second thermal | Types | (I) | (I) | (I) | (I) | (I) |
| transfer layer | Softening point of | 97 | 97 | 97 | 97 | 97 |
| | epoxy resin (° C.) | | | | | |
| Evaluation | Continuous | 15 | 12 | 10 | 10 | 7 |
| | recordability (times) | | | | | |
| | Sharpness | ∘ | ∘ | ∘ | ∘ | ∘ |
| | Peeling mode (upper | \textcircled{1} | \textcircled{1} | \textcircled{1} + \textcircled{2} | \textcircled{1} + \textcircled{2} | \textcircled{1} + \textcircled{2} |
| | row: black, lower | \textcircled{3} | \textcircled{3} | \textcircled{4} + \textcircled{6} | \textcircled{4} + \textcircled{6} | \textcircled{4} + \textcircled{6} |
| | row: red) | | | | | |

TABLE 9

| | | | | Sample | Sample | Sample |
|---|---|---|---|---|---|---|
| | | | Sample 25 | 26 | 27 | 28 |
| First | Types | | (I) | (II) | (III) | (I) |
| thermal | Softening point | | 128 | 97 | 128 | 128 |
| transfer | of epoxy resin | | | | | |
| layer | (° C.) | | | | | |
| | Tackifier | | Added | Added | Not | Added |
| | | | | | added | |
| Middle | Types | | (10) | (1) | (1) | (13) |
| layer | Binder | Types | EVA | SEBS | SEBS | Polyolefin |
| | | MFR | 2000 | 2.3 | 2.3 | — |
| | | (g/10 | | | | |
| | | min) | | | | |

| | | | | | |
|---|---|---|---|---|---|
| Second | Types | (I) | (I) | (I) | (I) |
| thermal | Softening point | 97 | 97 | 97 | 97 |
| transfer | of epoxy resin | | | | |
| layer | (° C.) | | | | |
| Evaluation | Continuous | 5 | 13 | 13 | 4 |
| | recordability | | | | |
| | (times) | | | | |
| | Sharpness | ◯ | ◯ | Δ | Δ |
| | Peeling mode | \textcircled{1} + \textcircled{2} | \textcircled{1} | \textcircled{1} | \textcircled{1} |
| | (upper row: | | | | |
| | black, lower | \textcircled{4} + \textcircled{6} | \textcircled{3} | \textcircled{3} | \textcircled{5} |
| | row: red) | | | | |

TABLE 10

| | | | Sample 16 | Sample 30 | Sample 31 | Sample 32 | Sample 33 |
|---|---|---|---|---|---|---|---|
| First thermal | Types | | (I) | (I) | (I) | (I) | (I) |
| transfer layer | Softening point of | | 128 | 128 | 128 | 128 | 128 |
| | epoxy resin (° C.) | | | | | | |
| | Tackifier | | Added | Added | Added | Added | Added |
| | Application | | 1.7 | 1.7 | 1.7 | 1.7 | 1.7 |
| | amount (g/m²) | | | | | | |
| Middle layer | Types | | (1) | (1) | (1) | (1) | (1) |
| | Binder | Types | SEBS | SEBS | SEBS | SEBS | SEBS |
| | | MFR | 2.3 | 2.3 | 2.3 | 2.3 | 2.3 |
| | | (g/10 min) | | | | | |

| | | | | | | |
|---|---|---|---|---|---|---|
| | Application | 1.0 | 0.1 | 0.2 | 1.5 | 2.0 |
| | amount (g/m²) | | | | | |
| Second thermal | Types | (I) | (I) | (I) | (I) | (I) |
| transfer layer | Softening point of | 97 | 97 | 97 | 97 | 97 |
| | epoxy resin (° C.) | | | | | |
| | Application | | | | | |
| | amount (g/m²) | | | | | |
| Evaluation | Continuous | 2.5 | 2.5 | 2.5 | 2.5 | 2.5 |
| | recordability (times) | | | | | |
| | Sharpness | ∘ | Δ | ∘ | ∘ | Δ |
| | Peeling mode (upper | \textcircled{1} | \textcircled{1} | \textcircled{1} | \textcircled{1} | \textcircled{1} |
| | row: black, lower | \textcircled{3} | \textcircled{3} | \textcircled{3} | \textcircled{3} | \textcircled{3} |
| | row: red) | | | | | |

From comparison between the samples 16 to 28 and the sample 29 in Tables 7 to 9, it has been found that a desired peeling mode can be completed by adjusting a balance between the SP values of the constituent components of the first thermal transfer layer, the second thermal transfer layer, and the middle layer with reference to FIG. 17, for example. As a result, it has been found that the thermal transfer recording medium that does not allow the color tones to easily become dusky and enables the color tones to be clearly separated into two colors even in the continuous thermal transfer recording, and furthermore enables the characters to be recorded with excellent sharpness without extra peeling.

From comparison between the samples 16 to 27 and the sample 28, it has been found that it is preferable to use a thermoplastic elastomer as the middle layer in consideration of further improvement in the continuous recordability.

From comparison between the sample 16 and the sample 26, it has been found that an epoxy resin having a softening point of preferably 95° C. or higher, more preferably 110° C. or higher, and particularly preferably 125° C. or higher is preferable as the epoxy resin of which the first thermal transfer layer is made. Further, from comparison between the sample 16 and the sample 27, it has been found that it is preferable to blend both of an acrylic adhesive and a tackifier in the epoxy resin of which the first thermal transfer layer is made.

From the sample 16 and the samples 30 to 33, it has been found that practically sufficient continuous recordability and sharpness can be achieved even if the application amount of the middle layer is changed. Of the sample 16 and the samples 30 to 33, the samples 16, 31, and 32 were found to be particularly excellent in continuous recordability and sharpness. In the samples 16, 31, and 32, the middle layer of the layers constituting the thermal transfer recording medium is the thinnest (a small application amount), and the thickness (the application amount) of the middle layer is thick enough to sufficiently exhibit the effects by the introduction of the middle layer.

In other words, in the sample 33, since the middle layer of the layers constituting the thermal transfer recording medium was not the thinnest but relatively thick, a transferred area (extra peeling) increased, and the sharpness deteriorated. Usually, as in the sample 33, when a thickness of one layer on a side closer to a heat source, of the adjacent layers, increases, a reaching temperature at an interface between the one layer and the other layer decreases, so that the transfer area is considered to decrease. However, when an interface reaching temperature decreases, a phenomenon in which an adhesive force between the middle layer and the second thermal transfer layer (between “51” and “52” in FIG. 6) is maintained relatively low may occur at the interface between the middle layer and the second thermal transfer layer. As a result, it is considered that, in a portion around the barcode, the adhesive force between the middle layer and the second thermal transfer layer was relatively lower than the adhesive force between the label material and the second thermal transfer layer (between “2” and “52” in FIG. 6), the rupture appeared between the middle layer and the second thermal transfer layer, and the excessive peeling increased.

On the other hand, in the sample 30, the middle layer was the thinnest layer of the layers constituting the thermal transfer recording medium, but the middle layer did not sufficiently fulfill an original function thereof since the application amount was a considerably small amount of 0.1 g/m², and it was confirmed that both the continuous recordability and the sharpness deteriorated.

### REFERENCE SIGNS LIST

1: Printing device
2: Printer tape
3: Ink ribbon
6: Thermal head
20: Heating element
31: Printing surface
32: Back surface
35: Base material layer
36: First ink layer
37: Second ink layer
42: First portion
43: Second portion
44: Printing pattern
45: Red pattern
46: Black pattern
47: Thermal transfer recording medium
48: Base material layer
50: First thermal transfer layer
51: Middle layer
52: Second thermal transfer layer
61: Mixed layer
62: First material
63: Second material
64: Third material
65: Fourth material
66: Fifth material
F₁: External force
T₁: First temperature
T₂: Second temperature
T₃: Third temperature
T_{R1}: Reaching temperature
T_{R2}: Reaching temperature

1. A thermal transfer recording medium comprising:
a base material layer having a first surface and a second surface; and
a first thermal transfer layer, a middle layer, and a second thermal transfer layer layered in this order in direct contact with each other on the first surface of the base material layer, wherein
the middle layer includes a thermoplastic elastomer.

2. The thermal transfer recording medium according to claim 1, wherein the thermoplastic elastomer has a Melt Mass-Flow Rate (MFR) of 1000 g/10 min or less at a temperature of 190° C. and a load of 2.16 kg, the melt mass flow rate being determined in accordance with a measurement method specified in ISO 1133-1:2011.

3. The thermal transfer recording medium according to claim 1, wherein the thermoplastic elastomer includes at least one of a styrene-based thermoplastic elastomer and an acetate ester-based thermoplastic elastomer.

4. The thermal transfer recording medium according to claim 3, wherein the thermoplastic elastomer includes at least one selected from the group consisting of a styrene-butadiene-styrene block copolymer (SBS), a styrene-ethylene-butene-styrene block copolymer (SEBS), and an ethylene-vinyl acetate copolymer (EVA).

5. The thermal transfer recording medium according to claim 3, wherein the thermoplastic elastomer includes a styrene-based thermoplastic elastomer containing styrene at a percentage content of 10 mass % or more and 70 mass % or less.

6. The thermal transfer recording medium according to claim 1, wherein the first thermal transfer layer includes an epoxy resin and an acrylic adhesive.

7. The thermal transfer recording medium according to claim 1, wherein the second thermal transfer layer includes a thermoplastic resin and wax.

8. A thermal transfer recording medium formed by layering a base material layer, a first ink layer including first ink, a middle layer, and a second ink layer including second ink in this order in which at least a part of the first ink layer and the second ink layer is thermally transferred to a printing medium, wherein
the thermal transfer recording medium is ruptured between the first ink layer and the base material layer or in the first ink layer when an external force is applied to the base material layer and the second ink layer in a direction in which the layers are separated from each other, in a first state in which the thermal transfer recording medium is heated to a first temperature or higher and a second temperature or lower and then cooled to a third temperature or lower, and
the thermal transfer recording medium is ruptured between the first ink layer and the second ink layer or in the second ink layer when the external force is applied in a second state in which the thermal transfer recording medium is heated to a temperature above the second temperature and then cooled to the third temperature or lower.

9. The thermal transfer recording medium according to claim 8, wherein
the thermal transfer recording medium has the lowest rupture strength between the first ink layer and the base material layer or in the first ink layer when the external force is applied in the first state, and
the thermal transfer recording medium has the lowest rupture strength between the first ink layer and the second ink layer or in the second ink layer when the external force is applied in the second state.

10. The thermal transfer recording medium according to claim 8, wherein the thermal transfer recording medium is ruptured between the middle layer and the second ink layer when the external force is applied in the second state.

11. The thermal transfer recording medium according to claim 10, wherein the thermal transfer recording medium has the lowest rupture strength between the middle layer and the second ink layer when the external force is applied in the second state.

12. The thermal transfer recording medium according to claim 10, wherein the middle layer includes a styrene-based thermoplastic elastomer.

13. The thermal transfer recording medium according to claim 12, wherein the styrene-based thermoplastic elastomer includes at least one of a styrene-butadiene-styrene block copolymer (SBS) and a styrene-ethylene-butene-styrene block copolymer (SEBS).

14. The thermal transfer recording medium according to claim 13, wherein a percentage content of styrene in the styrene-based thermoplastic elastomer is 10 mass % to 70 mass %.

15. The thermal transfer recording medium according to claim 10, wherein the middle layer includes an acetate ester-based thermoplastic elastomer.

16. The thermal transfer recording medium according to claim 15, wherein the acetate ester-based thermoplastic elastomer includes an ethylene-vinyl acetate copolymer (EVA).

17. The thermal transfer recording medium according to claim 10, wherein the first ink layer and the middle layer are mixed in the second state.

18. The thermal transfer recording medium according to claim 8, wherein the thermal transfer recording medium is ruptured in the middle layer when the external force is applied in the second state.

19. The thermal transfer recording medium according to claim 18, wherein the thermal transfer recording medium has the lowest rupture strength in the middle layer when the external force is applied in the second state.

20. The thermal transfer recording medium according to claim 18, wherein the middle layer includes at least one of a polyolefin-based resin and a long-chain alkyl-based resin.

21. The thermal transfer recording medium according to claim 8, wherein
the first ink layer includes at least a first material and a second material having a solubility parameter (SP value) higher than that of the first material,
the middle layer includes at least a third material, and
the second ink layer includes at least a fourth material and a fifth material having a solubility parameter (SP value) lower than that of the fourth material.

22. The thermal transfer recording medium according to claim 8, wherein the first temperature is equal to or higher than the third temperature.

23. The thermal transfer recording medium according to claim 8, wherein
the first state is a state in which the base material layer of the thermal transfer recording medium is heated to the first temperature or higher and the second temperature or lower and then cooled to the third temperature or lower, and
the second state is a state in which the base material layer of the thermal transfer recording medium is heated to a temperature above the second temperature and then cooled to the third temperature or lower.

24. The thermal transfer recording medium according to claim 1, wherein the middle layer is thinnest among layers constituting the thermal transfer recording medium.

25. A printing device configured to execute:
a heating step of heating a thermal transfer recording medium formed by layering a base material layer, a first ink layer including first ink, a middle layer, and a second ink layer including second ink in this order, in a state where the thermal transfer recording medium is in contact with a printing medium;
a cooling step of cooling the thermal transfer recording medium heated by the heating step; and
a transferring step of transferring at least a part of the first ink and the second ink to the printing medium by applying, in a direction in which the base material layer and the second ink layer are separated from each other, an external force to the base material layer and the second ink layer of the thermal transfer recording medium cooled by the cooling step, wherein
in the heating step and the cooling step,
a first state is set by heating a first portion of the thermal transfer recording medium to a first temperature or higher and a second temperature or lower and then cooling the first portion to a third temperature or lower, and a second state is set by heating a second portion of the thermal transfer recording medium to a temperature above the second temperature and then cooling the second portion to the third temperature or lower, and
in the transferring step,
the thermal transfer recording medium is ruptured between the first ink layer and the base material layer or in the first ink layer in the first portion of the thermal transfer recording medium by applying the external force, and the first ink and the second ink are transferred to the printing medium, and
the thermal transfer recording medium is ruptured between the first ink layer and the second ink layer or in the second ink layer in the second portion of the thermal transfer recording medium by applying the external force, and the second ink is transferred to the printing medium.

26. A cassette comprising:
the internally provided thermal transfer recording medium according to claim 1; and
an internally provided printing medium to which a part of the thermal transfer recording medium is thermally transferred.

27. The thermal transfer recording medium according to claim 3, wherein the thermoplastic elastomer is a styrene-based thermoplastic elastomer.
